(19) United States
(12) Patent Application Publication
(10) Pub. No.: US 2019/0162994 A1
(43) Pub. Date: May 30, 2019

(54) ELECTRONIC DEVICE

(71) Applicant: SHARP KABUSHIKI KAISHA, Sakai City (JP)

(72) Inventor: YOHSUKE FUJIKAWA, Sakai City (JP)

(21) Appl. No.: 16/203,310

(22) Filed: Nov. 28, 2018

(30) Foreign Application Priority Data
Nov. 30, 2017 (JP) 2017-230199

(51) Int. Cl. G02F 1/1339; G02F 1/1333; G02F 1/1335

(52) U.S. Cl. CPC G02F 1/1339; G02F 1/133305; G02F 2201/56; G02F 1/133602; G02F 1/133514

(57) ABSTRACT

An electronic device includes a substrate having a longitudinal shape and including a first terminal region disposed in a longitudinal-side substrate end section and a second terminal region disposed in a short-side substrate end section, an electrically conductive portion extending at least in a first direction along the first terminal region, a first terminal portion provided in the first terminal region and connected to a part of the electrically conductive portion, and a second terminal portion provided in the second terminal region and connected to another part of the electrically conductive portion that is spaced apart from the part thereof connected to the first terminal portion with respect to the first direction.

### CROSS REFERENCE TO RELATED APPLICATION

This application claims priority from Japanese Patent Application No. 2017-230199 filed on Nov. 30, 2017. The entire contents of the priority application are incorporated herein by reference.

### TECHNICAL FIELD

The technology described herein relates to an electronic device.

### BACKGROUND

Conventional examples of a liquid crystal display device are described in Japanese Unexamined Patent Application Publication Nos. 2001-264751 and 2017-90528. In the liquid crystal display device according to Japanese Unexamined Patent Application Publication No. 2001-264751, a chip-on-film (COF) film is connected to a liquid crystal cell on which a driver IC is implemented. A flexible printed circuit (FPC) with LED chips arranged thereon is also connected to the liquid crystal cell. A backlighting light guide member is disposed on a back surface of the liquid crystal cell. The FPC is folded onto the rear surface of the backlighting light guide member. In this way, the LED chips are arranged in the vicinity of an end surface of the backlighting light guide member. Meanwhile, the liquid crystal display device described in Japanese Unexamined Patent Application Publication No. 2017-90528 includes a curved display that is curved along an axis of curvature. The curved display includes a TFT substrate on which pixels are formed in a matrix, a counter substrate, and a seal material bonding the TFT substrate and the counter substrate each other. The width of the seal material with respect to the sides extending in a direction perpendicular to the axis of curvature is greater than the width of the seal material with respect to the sides extending in a direction parallel with the axis of curvature.

The liquid crystal display devices described in Japanese Unexamined Patent Application Publication Nos. 2001-264751 and 2017-90528 have a longitudinal shape. Generally, such liquid crystal display devices have a screen size of a ratio between a long-side dimension and a short-side dimension (aspect ratio) of 4:3 or 16:9, for example. In recent years, however, there has been a demand for a liquid crystal display device with a thin and long screen called “ultra-wide screen”, for example, with a greater long-side dimension ratio, for vehicle-mounting purposes, for example. Such liquid crystal display devices include thin and long wires and electrodes for display extending in the long-side direction. Conventionally, signals are applied to the wires and electrodes via a terminal portion disposed on one end side of the wires and electrodes. Accordingly, the electric resistance between the terminals of the wires and electrodes and the vicinity of the end portion on the opposite side from the terminal portion side is high, providing a potential cause for problems such as signal blunting.

### SUMMARY

The technology described herein was made in view of the above circumstances. An object is to suppress electric resistance variation in an electrically conductive portion.

An electronic device according to the technology described herein includes a substrate, an electrically conductive portion, a first terminal portion, and a second terminal portion. The substrate has a longitudinal shape and includes a first terminal region disposed in a longitudinal-side substrate end section and a second terminal region disposed in a short-side substrate end section. The electrically conductive portion extends at least in a first direction along the first terminal region. The first terminal portion is provided in the first terminal region and connected to a part of the electrically conductive portion. The second terminal portion is provided in the second terminal region and connected to another part of the electrically conductive portion that is spaced apart from the part thereof connected to the first terminal portion with respect to the first direction.

In this way, the electrically conductive portion extending at least in the first direction along the first terminal region of the substrate having the longitudinal shape is connected with the first terminal portion provided in the first terminal region and with the second terminal portion provided in the second terminal region. Accordingly, it is possible to apply signals to the electrically conductive portion from both the first terminal portion and the second terminal portion, for example. The second terminal portion is connected to the part of the electrically conductive portion spaced apart in the first direction from the part thereof connected with the first terminal portion. Accordingly, compared to if only the first terminal portion or the second terminal portion were connected to the electrically conductive portion, it becomes less likely that a difference will be caused between the combined electric resistance from the first terminal portion and the second terminal portion to one end side in the first direction of the longitudinal electrically conductive portion, and the combined electric resistance from the first terminal portion and the second terminal portion to the other end side. In this way, signal blunting and the like becomes less likely to occur in the electrically conductive portion. In addition, compared to if the electrically conductive portion were only connected with the first terminal portion or the second terminal portion and a decrease in electric resistance were made by increasing the thickness of the electrically conductive portion, for example, a decrease in manufacturing cost and the like can be achieved.

According to the technology disclosed herein, electric resistance variation in an electrically conductive portion can be suppressed.

### BRIEF DESCRIPTION OF THE DRAWINGS

FIG. 1 is a plan view of a liquid crystal panel according to a first embodiment.

FIG. 2 is a side view of the liquid crystal panel.

FIG. 3 is a plan view illustrating a circuit configuration of a display region in an array substrate of the liquid crystal panel.

FIG. 4 is a plan view illustrating a configuration of a display region of a CF substrate of the liquid crystal panel.

FIG. 5 is a plan view illustrating a circuit configuration of the array substrate.

FIG. 6 is a plan view illustrating a circuit configuration of an array substrate according to a second embodiment.

FIG. 7 is a plan view illustrating a circuit configuration of an array substrate according to a third embodiment.

FIG. 8 is a plan view of a liquid crystal panel according to a fourth embodiment.

FIG. 9 is a plan view illustrating a circuit configuration of an array substrate.

FIG. 10 is a perspective view of a liquid crystal panel according to a fifth embodiment.

FIG. 11 is a plan view of a liquid crystal panel according to another embodiment (1).

FIG. 12 is a plan view of a liquid crystal panel according to another embodiment (2).

FIG. 13 is a plan view of a liquid crystal panel according to another embodiment (3).

FIG. 14 is a plan view of a liquid crystal panel according to another embodiment (5).

FIG. 15 is a plan view of a liquid crystal panel according to another embodiment (6).

### DETAILED DESCRIPTION

### First Embodiment

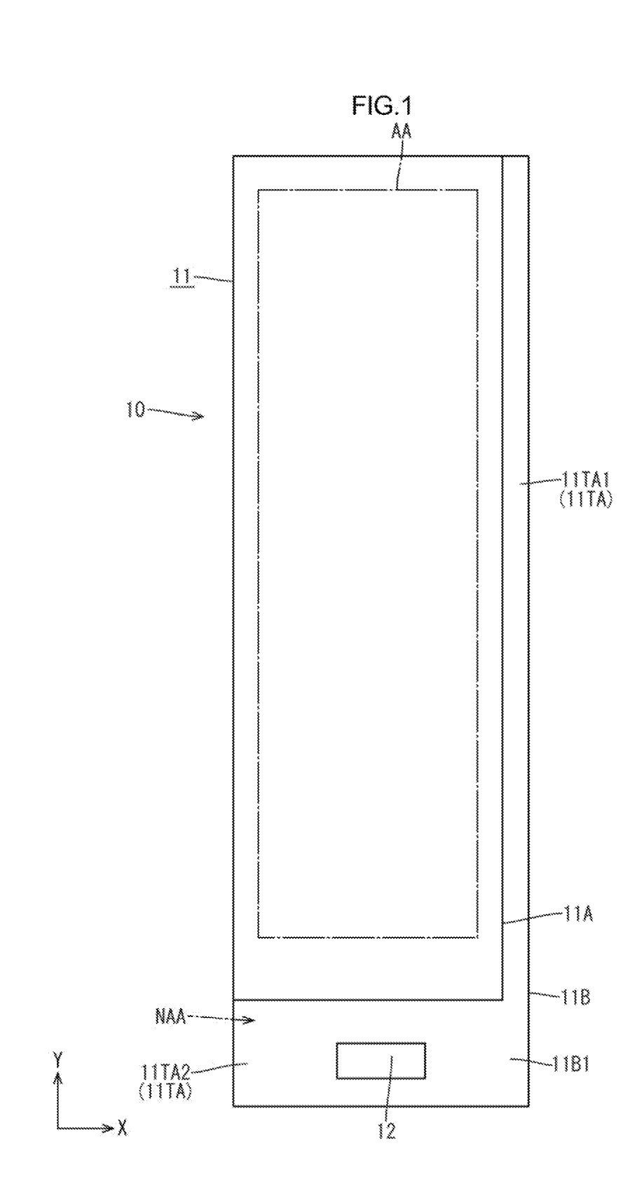

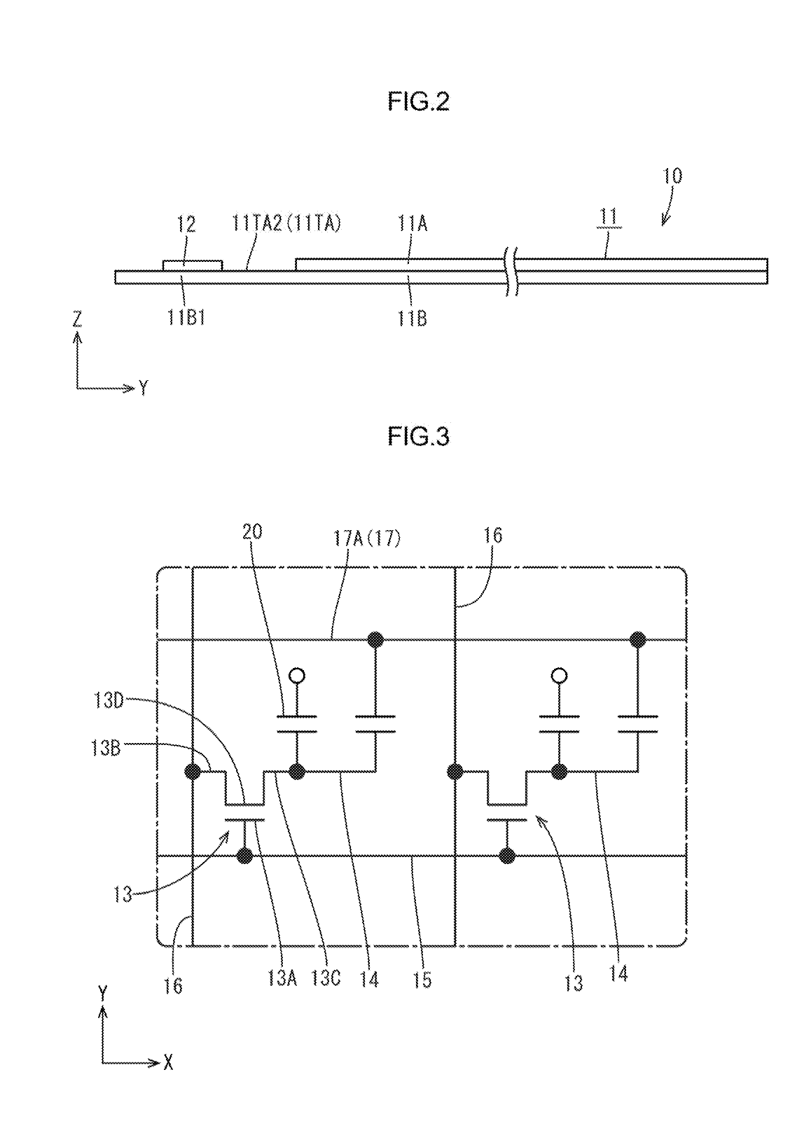

A first embodiment of the technology described herein will be described with reference to FIG. 1 to FIG. 5. In the present embodiment, a liquid crystal display device (display device) 10 will be described by way of example. In a part of each of the drawings, an X-axis, a Y-axis, and a Z-axis are indicated such that the respective axial directions correspond to the directions illustrated in the drawings. An upper side and a lower side in FIG. 2 correspond to the front side and the back side, respectively.

The liquid crystal display device 10, as illustrated in FIG. 1, is typically provided with a liquid crystal panel (electronic device, display panel) 11 configured to display an image, and a backlight device (illumination device) that is an external light source for irradiating the liquid crystal panel 11 with light utilized for a display. The liquid crystal panel 11 has an oblong planar shape of which the long-side direction, the short-side direction, and the thickness direction (normal to a plate surface of the liquid crystal panel 11) are respectively aligned with the Y-axis direction, the X-axis direction, and the Z-axis direction. In the following, the long-side direction of the liquid crystal panel 11 may be referred to as a first direction, and the short-side direction of the liquid crystal panel 11 may be referred to as a second direction. The liquid crystal panel 11 has a screen that includes a display region (active area) AA at the center for displaying an image, and a non-display region (non-active area) NAA in the outer peripheral end sides surrounding the display region AA. The display region AA and the non-display region NAA have a thin and long planar shape following the outer shape of the liquid crystal panel 11. In FIG. 1, the one-dot chain line indicates the outer shape of the display region AA, and the region outside the one-dot chain line is the non-display region NAA. The liquid crystal display device 10 according to the present embodiment is used in the dashboard of a vehicle, for example, in a mode of use where the liquid crystal display device 10 is assembled with the long sides thereof aligned with the horizontal direction, thus forming a part of the instrument panel. Accordingly, the liquid crystal display device 10 has a screen aspect ratio such that, compared to the conventional screen aspect ratios of 4:3 and 16:9, the long side ratio is higher. In other words, the liquid crystal display device 10 is thinner and longer than conventional examples. The liquid crystal display device 10 may be used for purposes other than being mounted on a vehicle.

The liquid crystal panel 11, as illustrated in FIG. 1 and FIG. 2, includes a pair of substrates 11A, 11B made of substantially transparent (optically transmissive) glass, which are bonded together with a predetermined interval therebetween. A liquid crystal layer (light modulation material) and a seal portion (both not illustrated) are interposed between the substrates 11A, 11B. The liquid crystal layer includes liquid crystal molecules that are a material of which the orientation changes in response to the application of an electric field. The seal portion is made of epoxy resin and the like, maintains a gap between the substrates 11A, 11B, and surrounds the liquid crystal layer to seal the liquid crystal layer. One of the substrates 11A, 11B on the front side (front surface side) is a CF substrate (counter substrate, common electrode substrate) 11A, and the other on the back side (rear surface side) is an array substrate (substrate, device substrate, element substrate) 11B. The substrates 11A, 11B each are oblong, and include a pair of long sides and a pair of short sides. A polarizing plate (not illustrated) is affixed onto the outer surface side of each of the substrates 11A, 11B.

The CF substrate 11A, as illustrated in FIG. 1, has a long-side dimension and a short-side dimension that are smaller than the corresponding dimensions of the array substrate 11B. The CF substrate 11A is bonded to the array substrate 11B with their one (upper side in FIG. 1) short-side end portions (short-side substrate ends) in the first direction aligned with each other, and with their one (left side in FIG. 1) long-side end portions (longitudinal-side substrate ends) in the second direction aligned with each other. Thus, of the array substrate 11B, the other (lower side in FIG. 1) short-side end portion in the first direction and the other (right side in FIG. 1) long-side end portion in the second direction form a CF substrate non-overlapping portion 11B1 that the CF substrate 11A does not overlap. The CF substrate non-overlapping portion 11B1 has a generally L-shape when viewed in plan in the non-display region NAA, and includes a long-side portion and a short-side portion. The CF substrate non-overlapping portion 11B1 has a front-side plate surface that is not covered by the CF substrate 11A and is exposed, forming a terminal region 11TA in which various terminals are provided. In the terminal region 11TA, components such as a driver 12, which will be described later, and flexible substrate (not illustrated) are mounted. Thus, the terminal region 11TA may be considered a mounting region. The terminal region 11TA includes a first terminal region (sub-mounting region) 11TA1 disposed in the long-side portion of the CF substrate non-overlapping portion 11B1, and a second terminal region (main mounting region) 11TA2 disposed in the short-side portion of the CF substrate non-overlapping portion 11B1. The first terminal region 11TA1 extends in the first direction. The second terminal region 11TA2 extends in the second direction. Accordingly, the first terminal region 11TA1 and the second terminal region 11TA2 extend in directions orthogonal to each other. The terminals provided in the terminal region 11TA will be described later.

The driver 12, as illustrated in FIG. 1 and FIG. 2, is selectively mounted in the second terminal region 11TA2, rather than the first terminal region 11TA1, of the terminal region 11TA of the array substrate 11B. The driver 12 includes an LSI chip incorporating a driver circuit, and is mounted in the second terminal region 11TA2 by Chip-On-Glass (COG) technology to process various signals transmitted by means of a flexible substrate mounted to the same second terminal region 11TA2. The driver 12 has a longitudinal shape of which the long-side direction is aligned with the second direction. The flexible substrate, not illustrated, includes a base material of an insulating and flexible synthetic resin mater (such as polyimide-based resin) on which a large number of wiring patterns (not illustrated) are formed. The flexible substrate is separately mounted in each of the first terminal region 11TA1 and the second terminal region 11TA2 of the terminal region 11TA. An end portion of the flexible substrate on the opposite side from the side connected to the liquid crystal panel 11 is connected to a control substrate (si final supply source), not illustrated, so that various signals supplied from the control substrate can be transmitted to the liquid crystal panel 11. In the following, when the flexible substrates are distinguished, the one mounted to the first terminal region 11TA1 may be referred to as a first flexible substrate, and the other mounted to the second terminal region 11TA2 may be referred to as a second flexible substrate.

The configuration of the display region AA of the liquid crystal panel 11 wall be described. The display region AA of the array substrate 11B, as illustrated in FIG. 3, is provided with at least thin-film transistors (TFTs; switching elements) 13 and pixel electrodes 14. A large number of TFTs 13 and a large number of pixel electrodes 14 are arranged side by side at intervals in the X-axis direction and the Y-axis direction, forming a matrix (rows and columns). Around the TFTs 13 and the pixel electrodes 14, gate wires (scan wire) 15 and source wires (signal wire) 16 are disposed orthogonal to (intersecting) each other. The gate wires 15 extend in the X-axis direction, and the source wires 16 extend in the Y-axis direction. The TFTs 13 include a gate electrode 13A connected to the gate wires 15, a source electrode 13B connected to the source wires 16, a drain electrode 13C connected to the pixel electrodes 14, and a channel portion 13D connected to the source electrode 13B and to the drain electrode 13C and including a semiconductor material (preferably, low-temperature polycrystalline silicon). The TFTs 13 are driven on the basis of scan signals supplied to the gate wires 15. Then, electric potentials relating to an image signal (data signal) supplied to the source wires 16 are supplied to the drain electrode 13C via the channel portion 13D, whereby the pixel electrodes 14 are charged with the electric potentials relating to the image signal. The pixel electrodes 14 are made of a transparent electrode material (such as ITO). The pixel electrodes 14 are disposed a region surrounded by the gate wires 15 and the source wires 16, have a substantially oblong planar shape, for example, and are arranged with the long-side direction thereof aligned with the first direction. The array substrate 11B is provided with a capacitive wire (electrically conductive portion) 17 that, by forming a capacitance between the capacitive wire 17 and the pixel electrodes 14, holds the electric potentials charged in the pixel electrodes 14. In the display region AA, capacitive branch wires 17A of the capacitive wire 17 are disposed. The capacitive branch wires 17A extend, in a position between a pair of gate wires 15 sandwiching the pixel electrodes 14 from both sides in the first direction, in parallel with the gate wires 15. The capacitive branch wires 17A are arranged to intersect the pixel electrodes 14 and the source wires 16 (see FIG. 5) arranged in the second direction. The capacitive branch wires 17A are arranged side by side at intervals in the first direction, and the number of the capacitive branch wires 17A corresponds to the number of the gate wires 15 and the number of the pixel electrodes 14 that are arranged in the first direction. The capacitive branch wires 17A are disposed in a layer different from those of the pixel electrodes 14 and the source wires 16 with an insulating film therebetween, and partly overlap the pixel electrodes 14, forming a capacitance between the capacitive branch wires 17A and the pixel electrodes 14. Preferably, the capacitive branch wires 17A are disposed in the same layer as that of the gate wires 15, and have the same electric potential as that of a common electrode 20, will be described later.

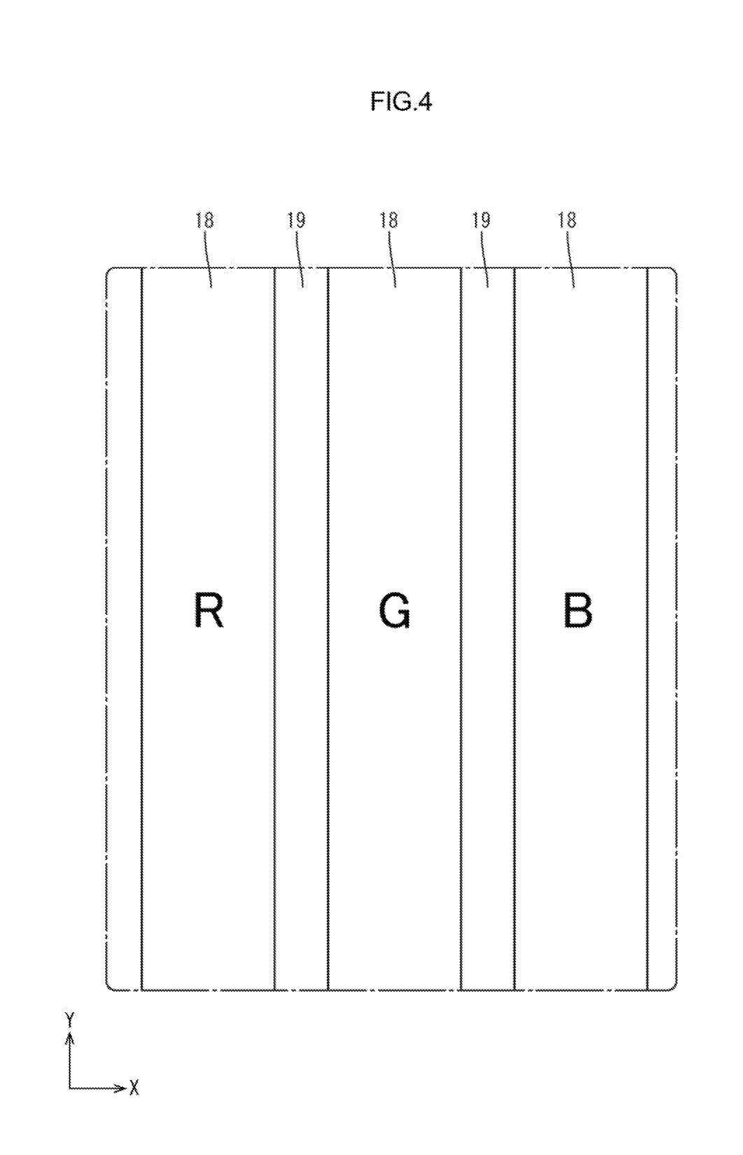

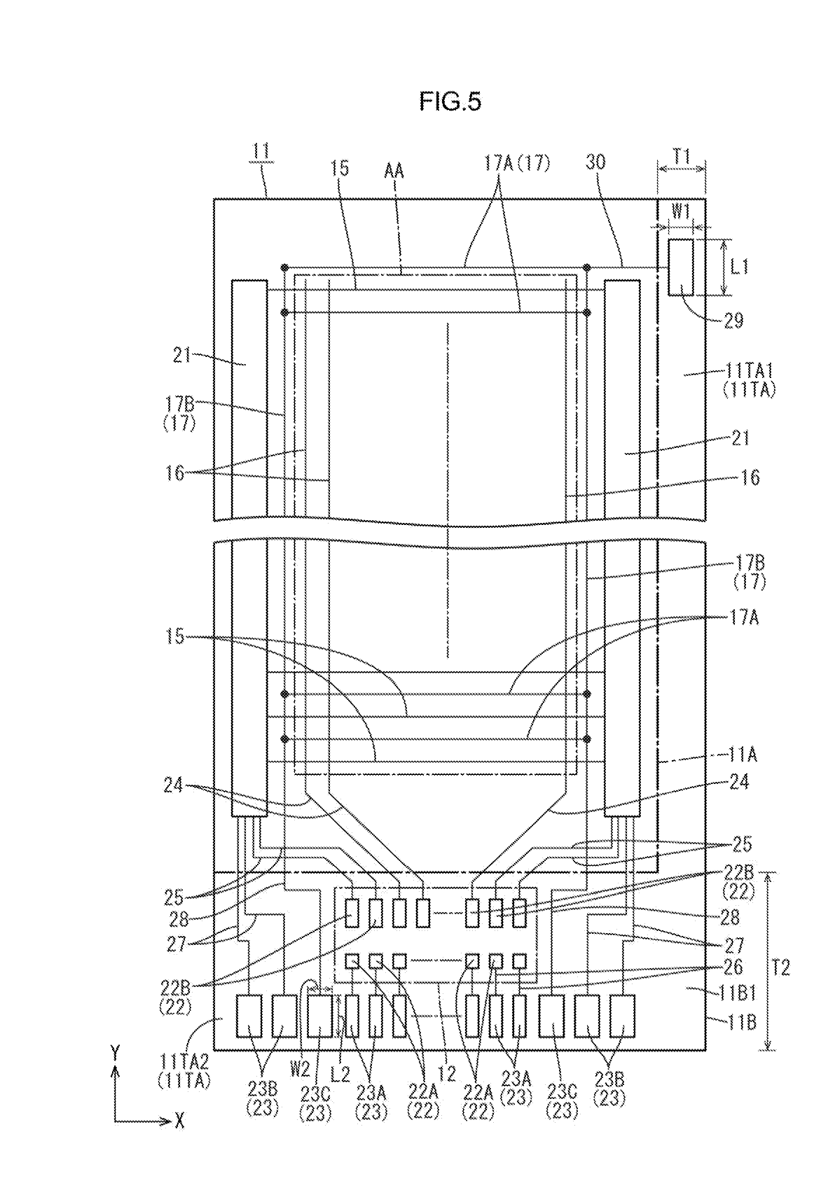

The display region AA of the CF substrate 11A, as illustrated in FIG. 4, is provided with at least color filters 18 and light blocking portions (black matrix) 19. The color filters 18 are configured to exhibit the three colors of blue (B) green (B), and red (R). A large number of the color filters 18 that exhibit mutually different colors are repeatedly arranged in the second direction (direction of extension of the gate wires 15). The color filters 18 extend in the first direction (direction of extension of the source wires 16). Thus, the color filters 18 are arrayed in a generally stripe shape. The color filters 18 are arranged to overlap, when viewed in plan, the pixel electrodes 14 on the array substrate 11B side. The light blocking portions 19 are provided so as to partition the spaces (color boundaries) between color filters 18 adjacent to each other with respect to the X-axis direction, and extend along the color filters 18 and the source wires 16. In the liquid crystal panel 11, the R, G, and B color filters 18 arranged in the X-axis direction and three pixel electrodes 14 opposing the respective color filters 18 constitute three colors of pixel portions. On the surface of the color filters 18 and the light blocking portions 19, as illustrated in FIG. 3, a solid common electrode 20 opposing the pixel electrodes 14 on the array substrate 11B side is provided. The common electrode 20 is maintained at a certain reference electric potential (common electric potential) at all times, making it possible to generate an electric field between the common electrode 20 and the pixel electrodes 14 in accordance with an electric potential difference therebetween. The liquid crystal layer includes liquid crystal molecules of which the orientation state changes in accordance with the electric field. The amount of light transmitted through the liquid crystal panel 11 changes depending on the orientation state on a pixel portion by pixel portion basis.

The configuration of the non-display region NAA of the array substrate 11B will be described. The non-display region NAA of the array substrate 11B, as illustrated in FIG. 5, is provided with a pair of monolithic circuit portions 21 configured to supply a scan signal to the gate wires 15 to drive the TFTs 13. The monolithic circuit portion 21 has a band shape extending in the first direction and is sandwiched between the display region AA and the first terminal region 11TA1 in the second direction. That is, the monolithic circuit portions 21 overlap the CF substrate 11A. The monolithic circuit portions 21 extend so as to intersect all of a large number of gate wires 15 arranged in the first direction. The monolithic circuit portions 21 are connected to the end portions of each of the large number of gate wires 15 and are configured to supply scan signals to the large number of gate wires 15 successively. The monolithic circuit portions 21 are monolithically provided on the array substrate 11B using, for example, the semiconductor material constituting the channel portion 13D of the TFTs 13. The monolithic circuit portions 21 include, for example, a circuit for outputting the scan signals at a predetermined timing, and a buffer circuit for amplifying the scan signals.

The non-display region NAA of the array substrate 11B, as illustrated in FIG. 5, is provided with a pair of capacitive trunk wires 17B of the capacitive wire 17. The capacitive trunk wires 17B extend in the first direction. Specifically, the pair of capacitive trunk wires 17B is disposed so as to sandwich the display region AA from both sides in the second direction. The pair of capacitive trunk wires 17B is sandwiched between the display region AA and the pair of monolithic circuit portions 21 in the second direction. That is, the capacitive trunk wires 17B are arranged closer to the display region AA than the monolithic circuit portions 21. The pair of capacitive trunk wires 17B extends so as to intersect all of a large number of capacitive branch wires 17A arranged in the first direction. The both end portions of the large number of capacitive branch wires 17A are connected to the capacitive trunk wires 17B. The capacitive trunk wires 17B supply the large number of capacitive branch wires 17A with a reference electric potential at all times. The capacitive trunk wires 17B are disposed in the same layer as that of the source wires 16, for example, so that a short circuit with the grate wires 15 being intersected is prevented. The capacitive trunk wires 17B are connected to the capacitive branch wires 17A through contact holes (not illustrated) formed in an insulating film interposed therebetween.

The configuration of the terminal region 11TA in the non-display region NAA of the array substrate 11B will be described. The terminal region 11TA, as illustrated in FIG. 5, is provided with wires and terminals for supplying signals to the source wires 16 and the monolithic circuit portions 21. The second terminal region 11TA2 of the terminal region 11TA is provided with a driver connection terminal portion 22 connected to the driver 12 as mounted, and a flexible substrate connection terminal portion 23 connected to the second flexible substrate as mounted. The driver connection terminal portion 22 is disposed in a region in which the driver 12 is mounted. The flexible substrate connection terminal portion 23 is disposed in a region in which the second flexible substrate is mounted. The driver connection terminal portion 22 includes input terminal portions 22A for inputting signals to the driver 12, and output terminal portions 22B to which signals from the driver 12 are outputted. The input terminal portions 22A are disposed closer to the flexible substrate connection terminal portion 23 than the output terminal portions 22B in the first direction. The output terminal portions 22B are disposed closer to the display region AA than the input terminal portions 22A in the first direction. The input terminal portions 22A and the output terminal portions 22B are respectively disposed side by side at intervals in the second direction. The input terminal portions 22A and the output terminal portions 22B are connected to the respective terminal portions (not illustrated) on the driver 12 side via an anisotropic conductive film (ACF). Most of the output terminal portions 22B are connected to source lead-out wires 24 led out from the source wires 16 to the second terminal region 11TA2 side, and output an image signal from the driver 12 to the source wires 16 via the source lead-out wires 24. Some of the output terminal portions 22B are connected to driver monolithic circuit lead-out wires 25 led out from the monolithic circuit portions 21 to the second terminal region 11TA2 side, and output signals (control signals, such as a clock signal and a start pulse signal) from the driver 12 to the monolithic circuit portions 21 via the driver monolithic circuit lead-out wires 25.

The flexible substrate connection terminal portion 23 includes driver terminal portions 23A for supplying signals to the input terminal portions 22A, monolithic circuit terminal portions 23B for supplying signals to the monolithic circuit portions 21, and capacitive wire main terminal portions (second terminal portions, main terminal portions) 23C for supplying signals to the capacitive wire 17. The driver terminal portions 23A, the monolithic circuit terminal portions 23B, and the capacitive wire main terminal portions 23C are disposed side by side at intervals in a predetermined order in the second direction. The driver terminal portions 23A supply, via driver connection wires 26 routed and formed between the driver terminal portions 23A and the input terminal portions 22A, the input terminal portions 22A with signals transmitted by means of the second flexible substrate. The monolithic circuit terminal portions 23B are connected to flexible substrate monolithic circuit lead-out wires 27 led out from the monolithic circuit portions 21 to the second terminal region 11TA2 side. The monolithic circuit terminal portions 23B output, via the flexible substrate monolithic circuit lead-out wires 27, signals (such as a high power supply signal and a low power supply signal) from the second flexible substrate to the monolithic circuit portions 21. The capacitive wire main terminal portions 23C are connected to a pair of second capacitive lead-out wires 28 that is led out from the capacitive trunk wires 17B of the capacitive wire 17 to the second terminal region 11TA2 side. The capacitive wire main terminal portions 23C output, via the second capacitive lead-out wires 28, signals from the second flexible substrate to the capacitive wire 17. The capacitive wire main terminal portions 23C are disposed in the second terminal region 11TA2 and are disposed in the vicinity of the respective end portions of the second terminal region 11TA2 in the second direction. The pair of capacitive wire main terminal portions 23C is respectively connected to the pair of capacitive trunk wires 17B via the pair of second capacitive lead-out wires 28. More specifically, the pair of capacitive wire main terminal portions 23C is each sandwiched between a group of the monolithic circuit terminal portions 23B disposed at each of the ends in the second direction, and a group of the driver terminal portions 23A disposed at the center.

Meanwhile, the first terminal region 11TA1 of the terminal region 11TA, as illustrated in FIG. 5, is provided with a capacitive wire sub-terminal portion (a first terminal portion, a sub-terminal portion) 29 connected to the first flexible substrate as mounted. The capacitive wire sub-terminal portion 29 is connected to a first capacitive lead-out wire 30 that is led out to the first terminal region 11TA1 side from the vicinity of a part to which the capacitive branch wires 17A of the capacitive wire 17 and one (on the right side in FIG. 5) of the capacitive trunk wires 17B are connected. The capacitive wire sub-terminal portion 29 outputs, via the first capacitive lead-out wire 30, signals from the first flexible substrate to the capacitive wire 17. In this way, because the capacitive wire 17 is connected with the capacitive wire sub-terminal portion 29 provided in the first terminal region 11TA1 and with the capacitive wire main terminal portions 23C provided in the second terminal region 11TA2, it is possible to supply signals from both the capacitive wire sub-terminal portion 29 and the capacitive wire main terminal portions 23C to the capacitive wire 17. In addition, the capacitive wire sub-terminal portion 29 is connected, in the first terminal region 11TA1 by means of the first capacitive lead-out wire 30, to a part spaced apart in the first direction from a part of the capacitive wire 17 to which the second capacitive lead-out wires 28 continuous with the capacitive wire main terminal portions 23C are connected. In this way, compared to if only one of the capacitive wire sub-terminal portion 29 and the capacitive wire main terminal portions 23C were connected to the capacitive wire, it becomes less likely that a difference will be caused between the combined electric resistance from the capacitive wire sub-terminal portion 29 and the capacitive wire main terminal portions 23C to one end side in the first direction of the longitudinal capacitive wire 17, and the combined electric resistance from the capacitive wire sub-terminal portion 29 and the capacitive wire main terminal portions 23C to the other end side. Specifically, of the pair of capacitive trunk wires 17B of the capacitive wire 17, in the case of the capacitive trunk wire 17B disposed on the first terminal region 11TA1 side (the right side of FIG. 5) in the second direction, the end portion on the driver 12 side in the first direction is supplied with a signal from the capacitive wire main terminal portion 23C via the second capacitive lead-out wire 28, while the end portion on the opposite side from the driver 12 side in the first direction is supplied with a signal from the capacitive wire sub-terminal portion 29 via the first capacitive lead-out wire 30. On the other hand, of the pair of capacitive trunk wires 17B, in the case of the capacitive trunk wire 17B disposed on the opposite side (the left side of FIG. 5) from the first terminal region 11TA1 side in the second direction, the end portion on the driver 12 side in the first direction is supplied with a signal from the capacitive wire main terminal portion 23C via the second capacitive lead-out wire 28, while the end portion on the opposite side from the driver 12 side in the first direction is supplied with a signal from the capacitive wire sub-terminal portion 29 via the first capacitive lead-out wire 30 and the capacitive branch wires 17A. Accordingly, in the capacitive wire 17, it is less likely that a difference is caused between the combined electric resistance from the capacitive wire sub-terminal portion 29 and the capacitive wire main terminal portions 23C to the end portion on the driver 12 side (second terminal region 11TA2 side) in the first direction, and the combined electric resistance from the capacitive wire sub-terminal portion 29 and the capacitive wire main terminal portions 23C to the end portion on the opposite side from the driver 12 side. In this way, signal blunting and the like is less likely to occur in the capacitive wire 17, and the electric potential holding function of the pixel electrodes 14 is enhanced, whereby improved display quality can be obtained. In addition, compared to if only one of the capacitive wire sub-terminal portion 29 and the capacitive wire main terminal portions 23C were connected to the capacitive wire and a decrease in electric resistance were made by increasing the thickness or width of the capacitive wire 17, a decrease in manufacturing cost or line width of the capacitive wire 17 can be achieved. Narrowing of the line width of the capacitive wire 17 makes it possible to achieve narrowing of the frame width of the liquid crystal panel 11. If the dimension by which the line width of the capacitive wire 17 is narrowed is equivalent to the dimension T1 of the first terminal region 11TA1 in the second direction, the same outer size of the liquid crystal panel 11 in the second direction as before can be maintained. Further, if the dimension by which the line width of the capacitive wire 17 is narrowed is greater than the dimension T1 of the first terminal region 11TA1 in the second direction, the outer size of the liquid crystal panel 11 in the second direction can be made smaller than before.

As illustrated in FIG. 5, the single capacitive wire sub-terminal portion 29 is disposed at the end portion of the first terminal region 11TA1 on the opposite side from the second terminal region 11TA2 side in the first direction. Thus, the first capacitive lead-out wire 30 extends substantially linearly in the X-axis direction, and is connected to the capacitive wire sub-terminal portion 29 and to the end portion of the capacitive wire 17 on the opposite side from the second terminal region 11TA2 side in the first direction. With respect to the monolithic circuit portions 21, the first capacitive lead-out wire 30 is disposed on the opposite side from the second terminal region 11TA2 side in the first direction, and is arranged so as to not intersect the monolithic circuit portions 21. In this way, the distance between the capacitive wire sub-terminal portion 29 and the capacitive wire main terminal portions 23C in the first direction is maximized. Accordingly, it becomes less likely that a difference will be caused between the combined electric resistance from the capacitive wire sub-terminal pardon 29 and the capacitive wire main terminal portions 23C to the end portion of the capacitive wire 17 on the second terminal region 11TA2 side in the first direction, and the combined electric resistance from the capacitive wire sub-terminal portion 29 and the capacitive wire main terminal portions 23C to the end portion on the opposite side from the second terminal region 11TA2 side. In addition, the first terminal region 11TA1 is only provided with the single capacitive wire sub-terminal portion 29 as a terminal to which the first flexible substrate is to be connected. Thus, the configuration of the first flexible substrate is simplified compared to the second flexible substrate, so that an inexpensive first flexible substrate can be used. Furthermore, the first terminal region 11TA1 does not have the driver 12 mounted therein, and does not include terminal portions for connection with the gate wires 15 or terminal portions for connection with the source wires 16. Accordingly, the area in which the first terminal region 11TA1 is formed can be made narrower, compared to the second terminal region 11TA2.

In contrast, in the second terminal region 11TA2, as illustrated in FIG. 5, the capacitive wire main terminal portions 23C are respectively disposed in the vicinity of the end portion on the first terminal region 11TA1 side in the second direction, and in the vicinity of the end portion on the opposite side from the first terminal region 11TA1 side. In this way, the two capacitive wire main terminal portions 23C are connected by means of the second capacitive lead-out wires 28 to the vicinity of both end portions of the capacitive wire 17 in the second direction. Accordingly, the combined electric resistance from an arbitrary position of the capacitive wire 17 to the capacitive wire sub-terminal portion 29 and the capacitive wire main terminal portions 23C is made uniform in the second direction as well. In addition, the capacitive wire sub-terminal portion 29 and the capacitive wire main terminal portion 23C disposed in the vicinity of the end portion on the first terminal region 11TA1 side in the second direction are diagonally arranged. Thus, the distance between the capacitive wire sub-terminal portion 29 and the capacitive wire main terminal portion 23C is maximized in the second direction as well as in the first direction. In this way, the combined electric resistance from an arbitrary position of the capacitive wire 17 to the capacitive wire sub-terminal portion 29 and the capacitive wire main terminal portions 23C is further made uniform.

As illustrated in FIG. 5, the capacitive wire sub-terminal portion 29 and the capacitive wire main terminal portions 23C have an oblong planar shape. The capacitive wire sub-terminal portion 29 has a dimension L1 in the first direction that is greater than a dimension W2 in the second direction of the capacitive wire main terminal portions 23C. The capacitive wire sub-terminal portion 29 has a dimension W1 in the second direction that is smaller than a dimension L2 in the first direction of the capacitive wire main terminal portions 23C. That is, the capacitive wire sub-terminal portion 29 is disposed such that the long-side direction thereof is aligned with the first direction and the short-side direction thereof aligned with the second direction. On the other hand, the capacitive wire main terminal portions 23C are disposed such that the long-side direction thereof is aligned with the first direction that is the long-side direction of the capacitive wire sub-terminal portion 29 and the short-side direction thereof is aligned with the second direction that is the short-side direction of the capacitive wire sub-terminal portion 29. Thus, the dimension W1 of the capacitive wire sub-terminal portion 29 in the second direction is smaller than the dimension L2 of the capacitive wire main terminal portions 23C in the first direction. In this way, it becomes possible to make a dimension T1 in the second direction of the first terminal region 11TA1 in which the capacitive wire sub-terminal portion 29 is disposed, smaller than a dimension T2 in the first direction of the second terminal region 11TA2 in which the capacitive wire main terminal portions 23C are disposed. As a result, it becomes possible to narrow the frame width in the second direction of the long side portion of the liquid crystal panel 11, resulting in superior exterior design. In addition, the dimension L1 in the first direction of the capacitive wire sub-terminal portion 29 is made greater than the dimension W2 in the second direction of the capacitive wire main terminal portions 23C. Accordingly, when the first flexible substrate to be connected with the capacitive wire sub-terminal portion 29 is mounted, position alignment in the first direction with respect to the capacitive wire sub-terminal portion 29 is facilitated, and connection reliability is improved. More specifically, the surface area of the capacitive wire sub-terminal portion 29 that is the product of the dimensions L1, W1 in the first direction and the second direction is greater than the surface area of the capacitive wire main terminal portions 23C that is the product of the dimensions L2, W2 in the first direction and the second direction. In this way, the connection reliability during the mounting of the first flexible substrate to be connected to the capacitive wire sub-terminal portion 29 is further improved.

As described above, in the present embodiment, the liquid crystal panel (electronic device) 11 includes the array substrate (substrate) 11B that has a longitudinal shape and includes the first terminal region 11TA1 disposed on the long side (longitudinal-side substrate end) and the second terminal region 11TA2 disposed on the short side (short-side substrate end), the capacitive wire 17 that is an electrically conductive portion extending at least in the first direction along the first terminal region 11TA1, the capacitive wire sub-terminal portion (first terminal portion) 29 provided in the first terminal region 11TA1 and connected to the capacitive wire 17 that is an electrically conductive portion, and the capacitive wire main terminal portions (second terminal portion) 23C provided in the second terminal region 11TA2 and connected to a part spaced apart in the first direction from a part of the capacitive wire 17, which is the electrically conductive portion, to which the capacitive wire stab-terminal portion 29 is connected.

In this way, the capacitive wire 17 that is the electrically conductive portion extending at least in the first direction along the first terminal region 11TA1 in the longitudinal array substrate 11B is connected with the capacitive wire sub-terminal portion 29 provided in the first terminal region 11TA1 and the capacitive wire main terminal portions 23C provided in the second terminal region 11TA2. Accordingly, for example, it is possible to apply signals to the capacitive wire 17 that is the electrically conductive portion from both the capacitive wire sub-terminal portion 29 and the capacitive wire main terminal portions 23C. The capacitive wire main terminal portions 23C are connected to the part spaced apart in the first direction from the part of the capacitive wire 17, which is the electrically conductive portion, to which the capacitive wire sub-terminal portion 29 is connected. Accordingly, compared to if the capacitive wire that is the electrically conductive portion is connected with only the capacitive wire sub-terminal portion 29 or the capacitive wire main terminal portions 23C, it becomes less likely that a difference will be caused between the combined electric resistance from the capacitive wire sub-terminal portion 29 and the capacitive wire main terminal portions 23C to one end side in the first direction of the longitudinal capacitive wire 17 that is the electrically conductive portion, and the combined electric resistance from the capacitive wire sub-terminal portion 29 and the capacitive wire main terminal portions 23C to the other end side. In this way, signal blunting and the like in the capacitive wire 17 that is the electrically conductive portion become less likely to occur. In addition, compared to if a decrease in electric resistance were made by, for example, increasing the thickness of the capacitive wire 17 that is the electrically conductive portion, while connecting only the capacitive wire sub-terminal portion 29 or the capacitive wire main terminal portions 23C to the capacitive wire that is the electrically conductive portion, a decrease in manufacturing cost and the like can be achieved.

The array substrate 11B has a pair of short sides. The second terminal region 11TA2 is selectively disposed along only one of the short sides. The capacitive wire sub-terminal portion 29 is disposed at least in the end portion of the first terminal region 11TA1 on the opposite side from the second terminal region 11TA2 side in the first direction. In this way, the distance between the capacitive wire sub-terminal portion 29 and the capacitive wire main terminal portions 23C in the first direction is maximized. Accordingly, it becomes even less likely that a difference will be caused between the combined electric resistance from the capacitive wire sub-terminal portion 29 and the capacitive wire main terminal portions 23C to one end side in the first direction of the capacitive wire 17 that is the electrically conductive portion, and the combined electric resistance from the capacitive wire sub-terminal portion 29 and the capacitive wire main terminal portions 23C to the other end side.

The capacitive wire 17 that is the electrically conductive portion also extends in the second direction along the second terminal region 11TA2, in addition to the first direction. The array substrate 11B has a pair of long sides. The first terminal region 11TA1 is selectively disposed along only one of the long sides. The capacitive wire main terminal portions 23C are disposed at least in the end portion of the second terminal region 11TA2 on the opposite side in the second direction from the first terminal region 11TA1 side. In this way, the capacitive wire sub-terminal portion 29 and the capacitive wire main terminal portions 23C are diagonally disposed, so that the distance between the capacitive wire sub-terminal portion 29 and the capacitive wire main terminal portions 23C in the second direction is also maximized. Accordingly, it becomes even less likely that a difference will be caused between the combined electric resistance from the capacitive wire sub-terminal portion 29 and the capacitive wire main terminal portions 23C to one end side in the first direction of the capacitive wire 17 that is the electrically conductive portion, and the combined electric resistance from the capacitive wire sub-terminal portion 29 and the capacitive wire main terminal portions 23C to the other end side.

The capacitive wire main terminal portions 23C are also disposed in the end portion of the second terminal region 11TA2 on the first terminal region 11TA1 side in the second direction. In this way, it is possible to connect two capacitive wire main terminal portions 23C to the vicinity of both end portions in the second direction of the capacitive wire 17 that is the electrically conductive portion. As a result, the combined electric resistance from an arbitrary position of the capacitive wire 17, which is an electrically conductive portion, to the capacitive wire sub-terminal portion 29 and the capacitive wire main terminal portions 23C is made uniform in the second direction as well.

The dimension L1 of the capacitive wire sub-terminal portion 29 in the first direction is greater than the dimension W2 of the capacitive wire main terminal portions 23C in the second direction along the second terminal region 11TA2. The dimension W1 of the capacitive wire sub-terminal portion 29 in the second direction is smaller than the dimension L2 of the capacitive wire main terminal portions 23C in the first direction. In other words, the dimension W1 of the capacitive wire sub-terminal portion 29 in the second direction is smaller than the dimension L2 of the capacitive wire main terminal portions 23C in the first direction. In this way, it becomes possible to make the dimension T2 of the first terminal region 11TA1 in the second direction smaller than the dimension T2 of the second terminal region 11TA2 in the first direction. In addition, the dimension L1 of the capacitive wire sub-terminal portion 29 in the first direction is greater than the dimension W2 of the capacitive wire main terminal portions 23C in the second direction. Accordingly, when an externally connected component to be connected to the capacitive wire sub-terminal portion 29 is mounted, position alignment with respect to the capacitive wire sub-terminal portion 29 in the first direction is facilitated, and connection reliability is improved.

The capacitive wire sub-terminal portion 29 has a surface area greater than that of the capacitive wire main terminal portions 23C. In this way, connection reliability is further improved when an externally connected component to be connected to the capacitive wire sub-terminal portion 29 is mounted.

The array substrate 11B includes the display region AA adjacent to the first terminal region 11TA1 and the second terminal region 11TA2, the pixel electrodes 14 disposed in the display region AA; the source wires (signal wires) 16 connected to the pixel electrodes 14, and the driver 12 selectively mounted in the second terminal region 11TA2 and supplying signals to the source wires 16. In this way, signals can be supplied from the driver 12 to the source wires 16 to charge the pixel electrodes 14 disposed in the display region AA. Because the driver 12 is selectively mounted in the second terminal region 11TA2, the number of the drivers mounted can be reduced compared to if the driver were mounted in the first terminal region 11TA1.

The array substrate 11B is also provided with the gate wires (scan wire) 15 disposed in the display region the TFTs (switching element) 13 disposed in the display region AA and connected to the gate wires 15 and the source wires 16, and the monolithic circuit portion 21 that is disposed between the display region AA and the first terminal region 11TA1 and extends in the first direction and is connected to the gate wires 15 to drive the TFTs 13. In this way, a scan signal can be supplied from the monolithic circuit portions 21 to drive the TFTs 13 disposed in the display region AA. The monolithic circuit portion 21 connected to the gate wires 15 is disposed between the display region AA and the first terminal region 11TA1 and extends in the first direction, and the presence of the gate wires 15 in the first terminal region 11TA1 is avoided. Thus, due to the absence of the driver 12 and the gate wires 15 in the first terminal region 11TA1, it is possible to narrow the area in which the first terminal region 11TA1 is formed compared to the second terminal region 11TA2.

The array substrate 11B is also provided with the pixel electrodes 14 and the capacitive wire 17 forming capacitance between the capacitive wire 17 and the pixel electrodes 14. The capacitive wire 17 provides an electrically conductive portion. Thus, the capacitive wire 17, by forming capacitance with the pixel electrodes 14, can hold an electric potential with which the pixel electrodes 14 are charged. When it is less likely that a difference will be caused between the combined electric resistance from the capacitive wire sub-terminal portion 29 and the capacitive wire main terminal portions 23C to one end side in the first direction, and the combined electric resistance from the capacitive wire sub-terminal portion 29 and the capacitive wire main terminal portions 23C to the other end side, the capacitive wire 17, being an electrically conductive portion, can provide an enhanced function of holding the electric potentials of the pixel electrodes 14. As a result, improved display quality can be obtained. In addition, compared to if a decrease in electric resistance were made by increasing the width of the capacitive wire, the width of the capacitive wire 17 can be kept narrow.

### Second Embodiment

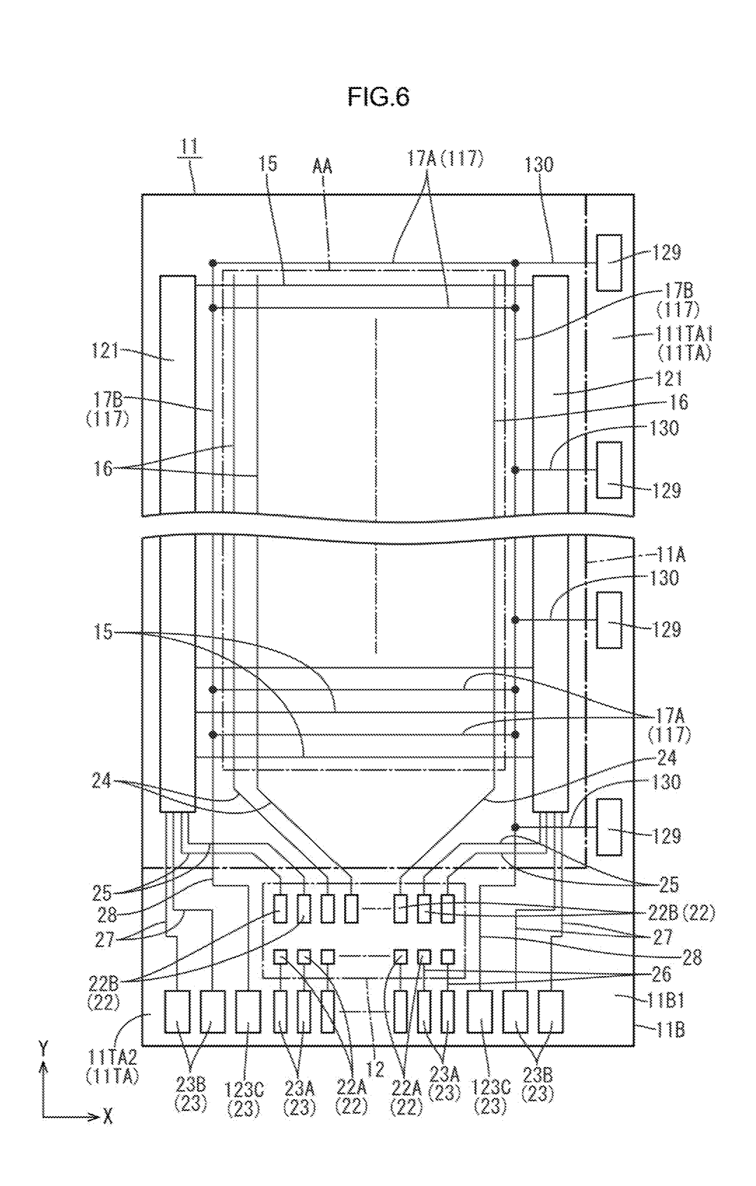

A second embodiment of the technology described herein will be described with reference to FIG. 6. In the second embodiment, the number of capacitive wire sub-terminal portions that are installed is modified. Redundant descriptions of structures, operations, and effects similar to those of the first embodiment will be omitted.

In the present embodiment, as illustrated in FIG. 6 capacitive wire sub-terminal portions 129 are disposed side by side at intervals in the first direction in a first terminal region 111TA1. Specifically, a total of four capacitive wire sub-terminal portions 129 are disposed at substantially regular intervals, from the vicinity of the end portion of the first terminal region 111TA1 on the opposite side from the second terminal region 111TA2 side in the first direction, to the vicinity of the end portion on the second terminal region 111TA2 side. The capacitive wire sub-terminal portions 129 are respectively connected with first capacitive wire lead-out wires 130. Of the total of four first capacitive wire lead-out wires 130, those connected to the two capacitive wire sub-terminal portions 129 disposed in the vicinity of both end portions in the first direction of the first terminal region 111TA1 are arranged so as to not intersect monolithic circuit portions 121, while those connected to the other two capacitive wire sub-terminal portions 129 are arranged so as to intersect the monolithic circuit portions 121. In this way, four capacitive wire sub-terminal portions 129 are connected to four parts of the capacitive wire 117 that are spaced apart from each other in the first direction. Accordingly, the combined electric resistance from an arbitrary position of the capacitive wire 117 to the capacitive wire sub-terminal portions 129 and capacitive wire main terminal portions 123C is made uniform regardless of the position in the first direction.

As described above, according to the present embodiment, the capacitive wire sub-terminal portions 129 are disposed side by side at intervals in the first direction in the first terminal region 111TA1. In this way, it becomes possible to connect a plurality of the capacitive wire sub-terminal portions 129 to the capacitive wire 117 that is the electrically conductive portion at a plurality of parts thereof in the first direction. Accordingly, the electric resistance from an arbitrary position of the capacitive wire 117 that is the electrically conductive portion to the capacitive wire sub-terminal portions 129 and the capacitive wire main terminal portions 123C are made uniform regardless of the position in the first direction.

### Third Embodiment

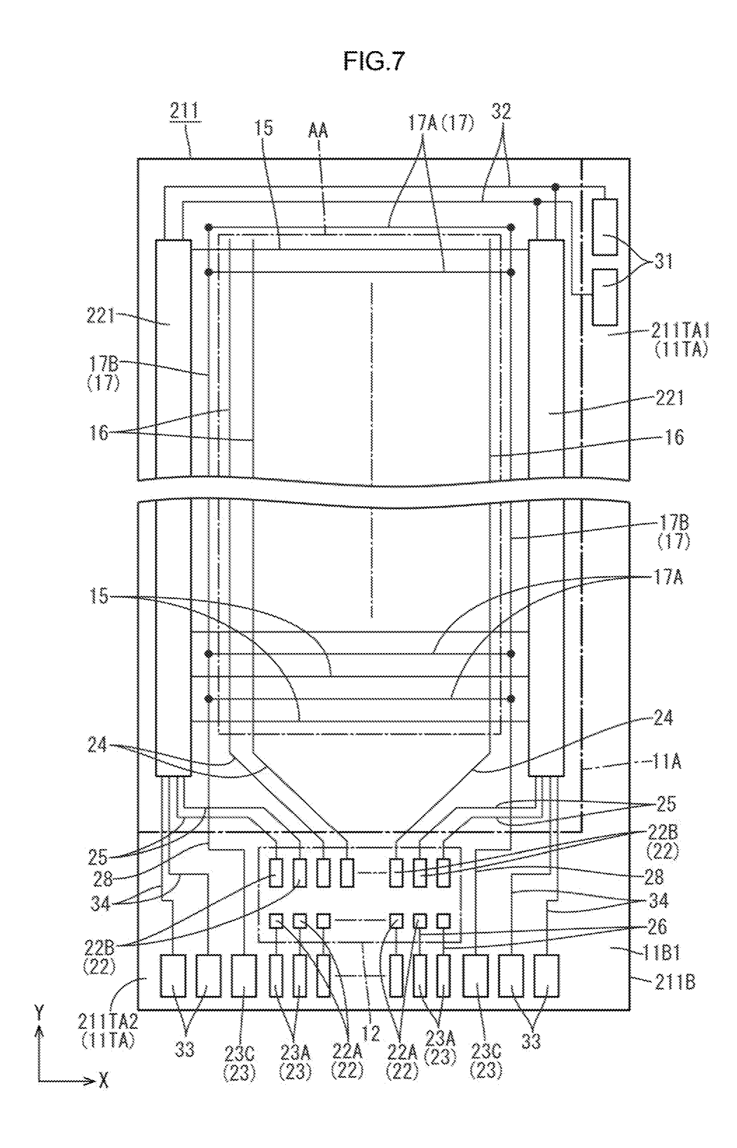

A third embodiment of the technology described herein will be described with reference to FIG. 7. In the third embodiment, the configuration of the first terminal region is modified from the first embodiment. Redundant descriptions of structures, operations, and effects similar to those of the first embodiment will be omitted.

In the present embodiment, as illustrated in FIG. 7, a first terminal region 211TA1 is provided with monolithic circuit sub-terminal portions (first terminal portion) 31, instead of the capacitive wire sub-terminal portion 29 of the first embodiment, for supplying signals to monolithic circuit portions 221. The monolithic circuit sub-terminal portions 31 are connected to first monolithic circuit lead-out wires 32 that are led out from the monolithic circuit portions 221 onto the first terminal region 211TA1 side. The monolithic circuit sub-terminal portions 31 output, via the first monolithic circuit lead-out wires 32, signals (such as a nigh power supply signal and a low power supply signal) from the second flexible substrate to the monolithic circuit portions 221. Meanwhile, a second terminal region 211TA2 is provided with monolithic circuit main terminal portions (second terminal portions) 33 for supplying signals to the monolithic circuit portions 221. The monolithic circuit main terminal portions 33 are connected to second monolithic circuit lead-out wires 34 that are led out from the monolithic circuit portions 221 onto the second terminal region 211TA2 side. The monolithic circuit main terminal portions 33 output, via the second monolithic circuit lead-out wires 34, signals from the first flexible substrate to the monolithic circuit portions 221. The monolithic circuit main terminal portions 33 and the second monolithic circuit lead-out wires 34 are respectively similar in configuration to the monolithic circuit terminal portions 23B and the flexible substrate monolithic circuit lead-out wires 27 (see FIG. 5) described in the first embodiment. Accordingly, redundant descriptions will be omitted.

Two monolithic circuit sub-terminal portions 31 are disposed side by side at intervals in the first direction, in the vicinity of the end portion of the first terminal region 211TA1 on the opposite side in the first direction from the second terminal region 211TA2 side. The two monolithic circuit sub-terminal portions 31 are respectively connected with the first monolithic circuit lead-out wires 32. The two first monolithic circuit lead-out wires 32 are led out from the end portion of the two monolithic circuit portions 221 on the opposite side from the second terminal region 211TA2 side in the first direction. The first monolithic circuit lead-out wires 32 are respectively connected to the two monolithic circuit portions 221. Thus, signals inputted from the second flexible substrate to the two monolithic circuit sub-terminal portions 31 are supplied via the two first monolithic circuit lead-out wires 32 to the two monolithic circuit portions 221. In this way, the monolithic circuit portions 221 are connected with the monolithic circuit sub-terminal portions 31 provided in the first terminal region 211TA1 and the monolithic circuit main terminal portions 33 provided in the second terminal region 211TA2. Accordingly, it is possible to supply signals from both the monolithic circuit sub-terminal portions 31 and the monolithic circuit main terminal portions 33 to the monolithic circuit portions 221. In addition, in the first terminal region 211TA1, the monolithic circuit sub-terminal portions 31 are connected, by means of the first monolithic circuit lead-out wires 32, to a part spaced apart in the first direction from a part of the monolithic circuit portions 221 to which the second monolithic circuit lead-out wires 34 continuous with the monolithic circuit main terminal portions 33 are connected. In this way, compared to if only one of the monolithic circuit sub-terminal portions 31 and the monolithic circuit main terminal portions 33 were connected to the monolithic circuit portions, it becomes less likely that a difference will be caused between the combined electric resistance from the monolithic circuit sub-terminal portions 31 and the monolithic circuit main terminal portions 33 to one end side in the first direction of the longitudinal monolithic circuit portions 221, and the combined electric resistance from the monolithic circuit sub-terminal portions 31 and the monolithic circuit main terminal portions 33 to the other end side. In this way, a voltage drop is less likely to be caused in the signals outputted from the monolithic circuit portions 221 for driving the TFTs. Further, compared to if a decrease in electric resistance were made by increasing the width of the monolithic circuit portions, the width of the monolithic circuit portions 221 can be kept narrow. In this way, it becomes possible to narrow the frame width of the liquid crystal panel 211 in the second direction, resulting in superior exterior design. The dimensional relationships between the monolithic circuit sub-terminal portions 31 and the monolithic circuit main terminal portions 33 with respect to the first direction and the second direction are similar to the dimensional relationships between the capacitive wire sub-terminal portion 29 and the capacitive wire main terminal portions 23C with respect to the first direction and the second direction described with reference to the first embodiment (see FIG. 5)

As described above, in the present embodiment, the array substrate 211B is provided with the TFTs and the monolithic circuit portions 221 for driving the TFTs, where the monolithic circuit portions 221 include an electrically conductive portion. In this way, the TFTs can be driven by means of the monolithic circuit portions 221. Because the monolithic circuit portions 221 include an electrically conductive portion, it becomes less likely that a difference will be caused between the combined electric resistance from the monolithic circuit sub-terminal portions 31 and the monolithic circuit main terminal portions 33 to one end side the first direction, and the combined electric resistance from the monolithic circuit sub-terminal portions 31 and the monolithic circuit main terminal portions 33 to the other end side. Accordingly, a voltage drop is less likely to be caused in the signals for driving the TFTs. In addition, compared to if a decrease in electric resistance were made by increasing the width of the monolithic circuit portions, the width of the monolithic circuit portions 221 can be kept narrow.

### Fourth Embodiment

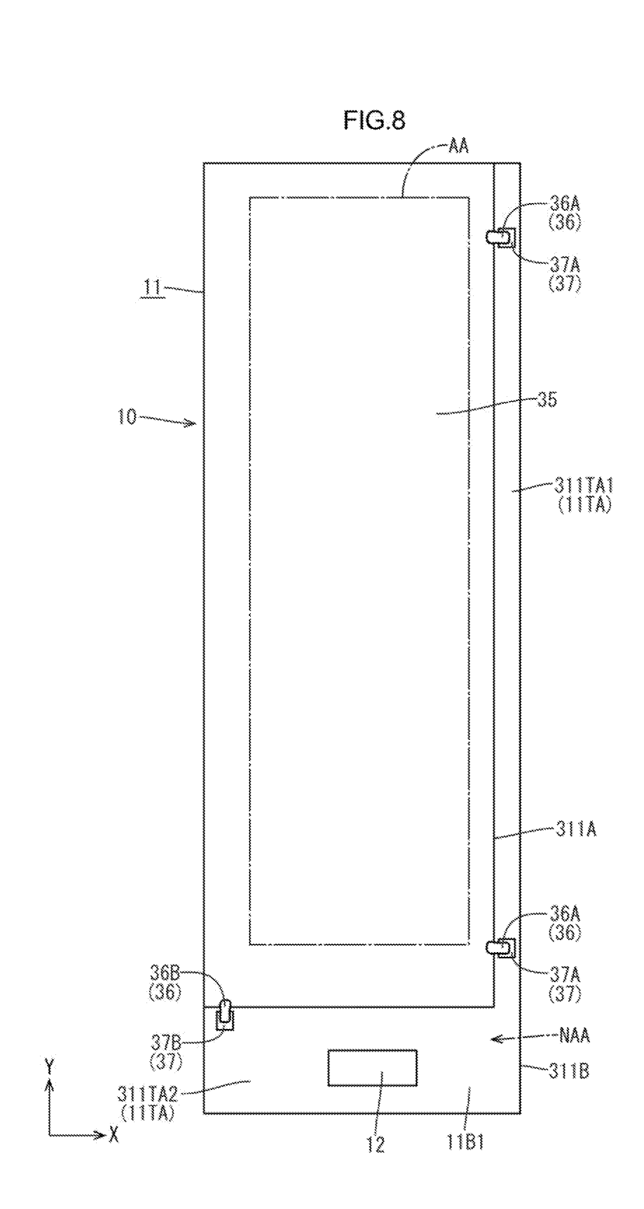

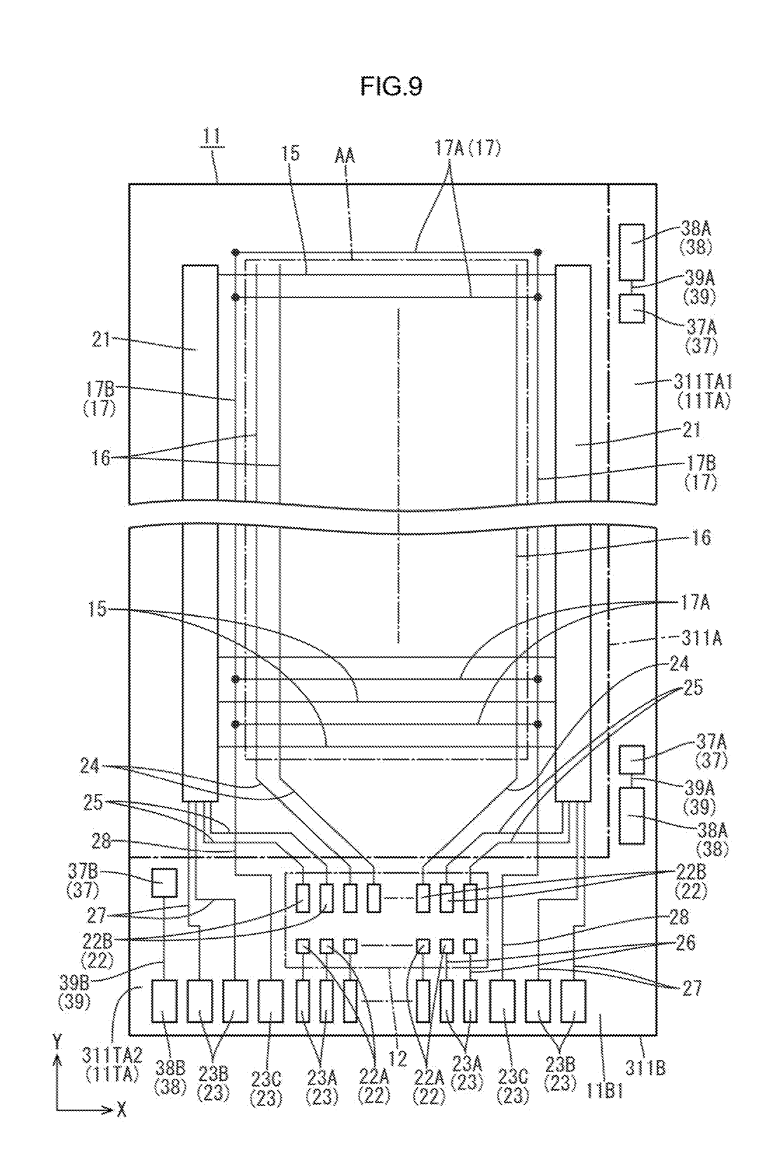

A fourth embodiment of the technology described herein will be described with reference to FIG. 8 or FIG. 9. In the fourth embodiment, the configuration of the CF substrate is modified from the first embodiment. Redundant descriptions of structures, operations, and effects similar to those of the first embodiment will be omitted.

In the present embodiment, as illustrated in FIG. 8, a CF substrate 311A includes a shield electrode (electrically conductive portion) 35 on a plate surface on the front side, i.e., on the opposite side from the array substrate 311B side. The shield electrode 35 is made of the same transparent electrode material (such as ITO) as that of the pixel electrodes and the like. The shield electrode 35 extends in both the first direction and the second direction on a front-side plate surface of the CF substrate 311A, and is formed as a solid film over the plate surface substantially entirely. The shield electrode 35 is connected with one end side of an electrically conductive paste portion 36 that spans between the array substrate 311B and the CF substrate 311A. The electrically conductive paste portion 36 is made of a silver paste material and the like. The other end side of the electrically conductive paste portion 36 is connected to the array substrate 311B, so that a ground potential (signal) can be supplied to the shield electrode 35. The shield electrode 35 is placed at ground potential, blocking unwanted radiation from the circuits provided on the array substrate 311B.

As illustrated in FIG. 9, the array substrate 311B is provided with a shield pad portion 37 connected to the other end side of the electrically conductive paste portion 36, a shield terminal portion 38 connected to the shield pad portion 37, and a shield connection wire 39 connecting the shield pad portion 37 and the shield terminal portion 38. The shield pad portion 37 includes a first shield pad portions 37A disposed in a first terminal region 311TA1, and a second shield pad portion 37B disposed in a second terminal region 311TA2. The electrically conductive paste portion 36 is disposed in both the first terminal region 311TA1 and the second terminal region 311TA2. The electrically conductive paste portion 36 includes first electrically conductive paste portions 36A that are disposed in the first terminal region 311TA1 and connected to the first shield pad portions 37A, and a second electrically conductive paste portion 36B that is disposed in the second terminal region 311TA2 and connected to the second shield pad portion 37B. The shield terminal portion 38 includes first shield terminal portions (first terminal portion) 38A disposed in the first terminal region 311TA1, and a second shield terminal portion (second terminal portion) 38B disposed in the second terminal region 311TA2. The first shield terminal portions 38A are supplied with ground potential from the first flexible substrate mounted to the first terminal region 311TA1. The second shield terminal portion 38B is supplied with ground potential from the second flexible substrate mounted to the second terminal region 311TA2. One second shield pad portion 37B and one second shield terminal portion 38B are disposed in the vicinity of the end portion of the second terminal region 311TA2 on the opposite side from the first terminal region 311TA1 side in the second direction. On the other hand, in the first terminal region 311TA1, one first shield pad portion 37A and one first shield terminal portion 38A are disposed in the vicinity of the end portion on the second terminal region 311TA2 side in the first direction, and another first shield pad portion 37A and another first shield terminal portion 38A are disposed in the vicinity of the end portion on the opposite side. The shield connection wire 39 includes first shield connection wires 39A that are disposed in the first terminal region 311TA1 and connects the first shield pad portions 37A and the first shield terminal portions 38A, and a second shield connection wire 39B that is disposed in the second terminal region 311TA2 and connects the second shield pad portion 37B and the second shield terminal portion 38B.

Thus, as illustrated in FIG. 9, the shield electrode 35 is connected with the first shield terminal portions 38A provided in the first terminal region 311TA1 and with the second shield terminal portion 38B provided in the second terminal region 311TA2. Accordingly, it is possible to supply ground potential to the shield electrode 35 from both the first shield terminal portions 38A and the second shield terminal portion 38B. In addition, one of the first shield terminal portions 38A is connected, in the first terminal region 311TA1 and by means of the first electrically conductive paste portion 36A, to a part spaced apart in the first direction from a part of the shield electrode 35 to which the second electrically conductive paste portion 36B continuous with the second shield terminal portion 38B is connected. In this way, compared to if only one of the first shield terminal portion 38A and the second shield terminal portion 38B were connected to the shield electrode, it becomes less likely that a difference will be caused between the combined electric resistance from the first shield terminal portions 38A and the second shield terminal portion 38B to one end side in the first direction of the longitudinal shield electrode 35 and the combined electric resistance from the first shield terminal portions 38A and the second shield terminal portion 38B to the other end side. In this way, a sufficient blocking effect due to the shield electrode 35 can be obtained. Further, compared to if a decrease in electric resistance were made by increasing the thickness of the shield electrode, a greater amount of light transmitted by the shield electrode 35 can be ensured. Accordingly, the brightness of the display image is improved and superior display quality can be obtained. In addition, a decrease in power consumption can also be achieved in a preferable manner. The dimensional relationships in the first direction and the second direction between the first shield terminal portions 38A and the second shield terminal portion 38B are similar to the dimensional relationships in the first direction and the second direction between the capacitive wire sub-terminal portion 29 and the capacitive wire main germinal portions 23C described in the first embodiment (see FIG. 5).

As described above, the present embodiment is provided with the CF substrate (counter substrate) 311A that is disposed so as to oppose the array substrate 311B and provided with the shield electrode 35 on the plate surface on the opposite side from the array substrate 311B side, the shield electrode 35 providing an electrically conductive portion. In this way, unwanted radiation generated from the array substrate 311B can be blocked by means of the shield electrode 35. Because the shield electrode 35 is an electrically conductive portion, it becomes less likely that a difference will be caused between the combined electric resistance from the first shield terminal portions 38A and the second shield terminal portion 38B to one end side in the first direction, and the combined electric resistance from the first shield terminal portions 38A and the second shield terminal portion 38B to the other end side, whereby the unwanted radiation blocking function is improved. In addition, compared to if a decrease in electric resistance were made by increasing the thickness of the shield electrode, a decrease in manufacturing cost can be achieved and improved display quality can be obtained.

The CF substrate 311A is disposed so as to not overlap the first shield terminal portions (first terminal portion) 38A and the second shield terminal portion (second terminal portion) 38B. The electrically conductive paste portion 36 is disposed spanning between the array substrate 311B and the CF substrate 311A, and is connected to the shield electrode 35 and to the first shield terminal portions 38A and the second shield terminal portion 38B. In this way, the first shield terminal portions 38A and the second shield terminal portion 38B, which do not overlap the CF substrate 311A, are connected, by means of the electrically conductive paste portion 36 spanning between the array substrate 311B and the CF substrate 311A, to the shield electrode 35 provided on the CF substrate 311A.

### Fifth Embodiment

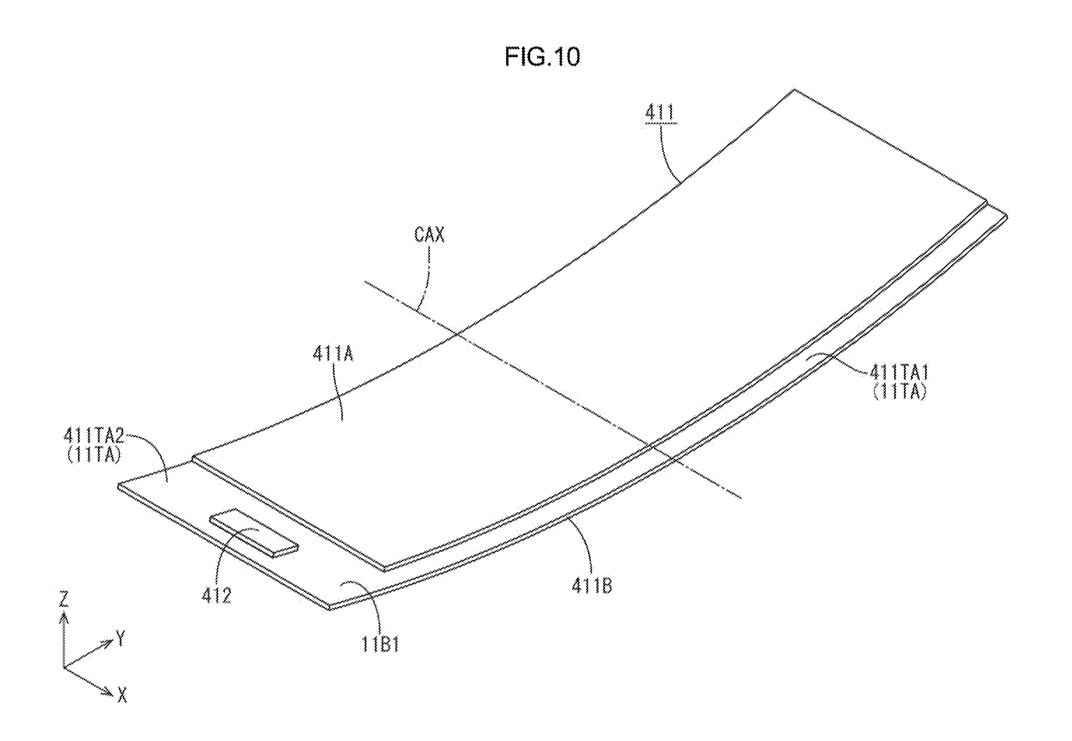

A fifth embodiment of the technology described herein will be described with reference to FIG. 10. The fifth embodiment differs from, the first embodiment in that the liquid crystal panel is curved. Redundant descriptions of structures, operations, and effects similar to those of the first embodiment will be omitted.

As illustrated in FIG. 10, in the present embodiment, a liquid crystal panel 411 is curved in a generally substantially arc shape. Specifically, the central portion in the long-side direction (first direction) of the liquid crystal panel 411 is bent toward the back side, and both end portions in the long-side direction are disposed closer to the front side (inwardly warped shape). The liquid crystal panel 411 has an axis of curvature CAX of which the axis direction is aligned with the second direction along a second terminal region 411TA2. Thus, the direction in which the liquid crystal panel 411 is curved (the direction in which the curvature of the plate surface changes) is aligned with the first direction along a first terminal region 411TA1. The axis of curvature CAX of the liquid crystal panel 411, with respect to the Z-axis direction, is disposed on the CF substrate 411A side on the opposite side from the array substrate 411B side. That is, the CF substrate 411A is arranged closer to the axis of curvature CAX than the array substrate 411B with respect to the Z-axis direction. In other words, the array substrate 411B and the CF substrate 411A of the liquid crystal panel 411 have their plate surfaces curving about the axis of curvature CAX, which is parallel with the direction in which color filters exhibiting different colors are arranged (see FIG. 4). When the array substrate 411B and the CF substrate 411A are curved about the axis of curvature CAX, the positional relationship between the color filters on the CF substrate 411A side and the pixel electrodes on the array substrate 411B side could vary with respect to the curving direction. In this respect, the array substrate 411B and the CF substrate 411A are curved about the axis of curvature CAX that is parallel with the direction in which the color filters exhibiting different colors are arranged. Thus, even if the positional relationship between the color filters and the pixel electrodes is varied with respect to the curving direction due to the curve, color mixing does not easily occur because each color of the color filters extends and a large number of pixel portions exhibiting the same color are disposed side by side in the curving direction (see FIG. 4). In addition, the driver 412 is selectively mounted in the second terminal region 411TA2 extending in parallel with the axis of curvature CAX. Accordingly, compared to if mounted on the first terminal region 411TA1 side, the driver 412 is less likely to deform due to the curving of the array substrate 411B and the CF substrate 411A. The configurations of the color filter and pixel electrodes and the like are as described in the first embodiment with reference to FIG. 3 and FIG. 4, for example.

As described above, according to the present embodiment, the plate surface of the array substrate 411B is curved about the axis of curvature CAX that is parallel with the second direction along the second terminal region 411TA2. In this way, because the driver 412 is mounted in the second terminal region 411TA2, compared to if the driver were mounted in the first terminal region 411TA1, deformation due to the curving of the array substrate 411B is less likely to occur.

The pixel electrodes are disposed side by side in each of the first direction and the second direction. The CF substrate 411A is disposed so as to oppose the array substrate 411B. The CF substrate 411A is provided with the color filters each disposed so as to overlap the pixel electrodes and exhibiting different colors, the color filters extending in the first direction and arranged in the second direction. When the array substrate 411B and the CF substrate 411A are curved about the axis of curvature, the positional relationship between the color filters and the pixel electrodes with respect to the curving direction may vary. In this respect, the array substrate 411B and the CF substrate 411A are curved about the axis of curvature that is parallel with the second direction, i.e., the direction in which the color filters exhibiting different colors are arranged. Accordingly, even if the positional relationship between the color filters and the pixel electrodes is varied with respect to the curving direction due to the curve, color mixing does not easily occur because the color filters each exhibiting the same color extend in the curving direction.

### Other Embodiments

The technology described herein is not limited to the embodiments described above and with reference to the drawings. The following embodiments may be included in the technical scope.

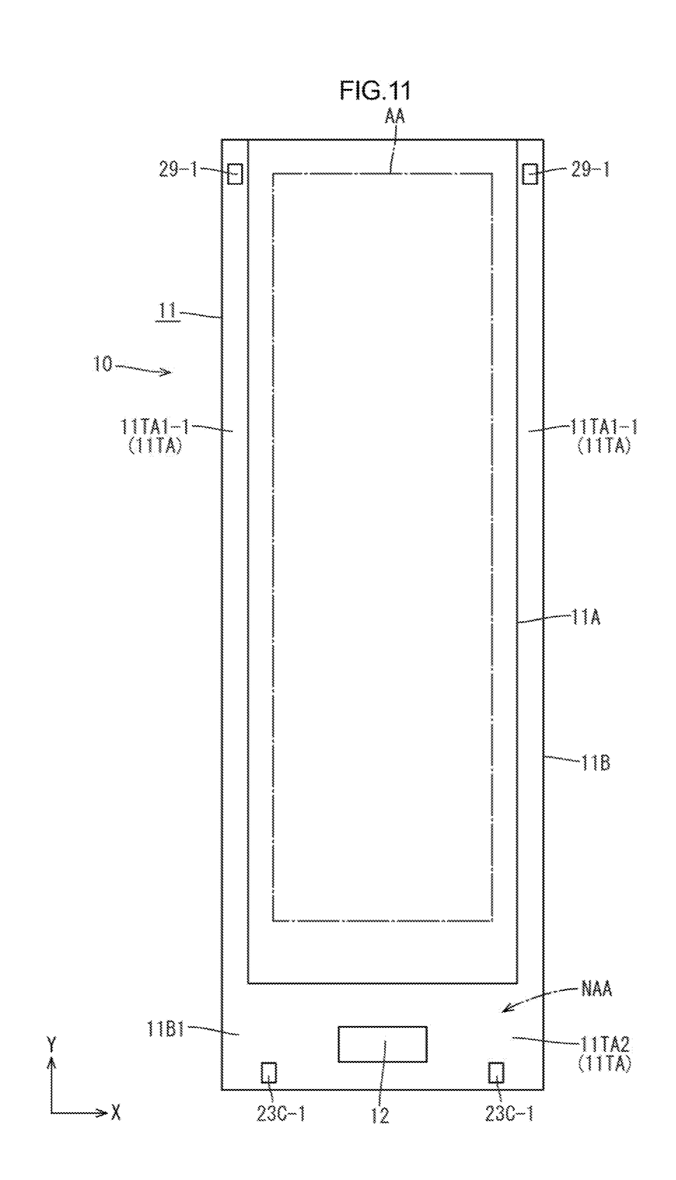

(1) A modification of the first embodiment may be provided with a pair of first terminal regions 11TA1-1, as illustrated in FIG. 11. In this case, preferably, the pair of first terminal regions 11TA1-1 is respectively provided with capacitive wire sup-terminal portions 29-1. In FIG. 11, the capacitive wire sub-terminal portions 29-1 and capacitive wire main terminal portions 23C-1 are illustrated.

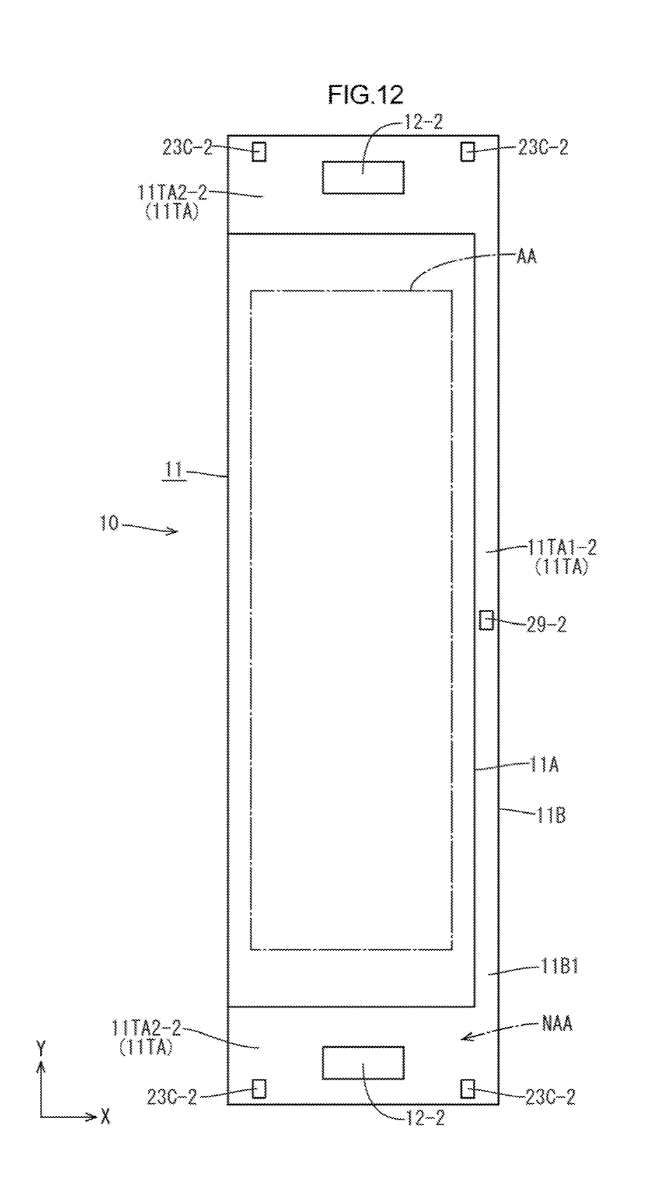

(2) A modification of the first embodiment may be provided with a pair of second terminal regions 11TA2-2, as illustrated in FIG. 12. In this case, preferably, the pair of second terminal regions 11TA2-2 is respectively provided with drivers 12-2 and capacitive wire main terminal portions 23C-2. Preferably, a capacitive wire sub-terminal portion 29-2 is disposed at a position equally dividing the first terminal region 111TA1-2 in the first direction. For example, when the capacitive wire sub-terminal portion 29-2 provided at one location, the capacitive wire sub-terminal portion 29-2 is preferably disposed at substantially the center in the first direction in the first terminal region 11TA1-2.

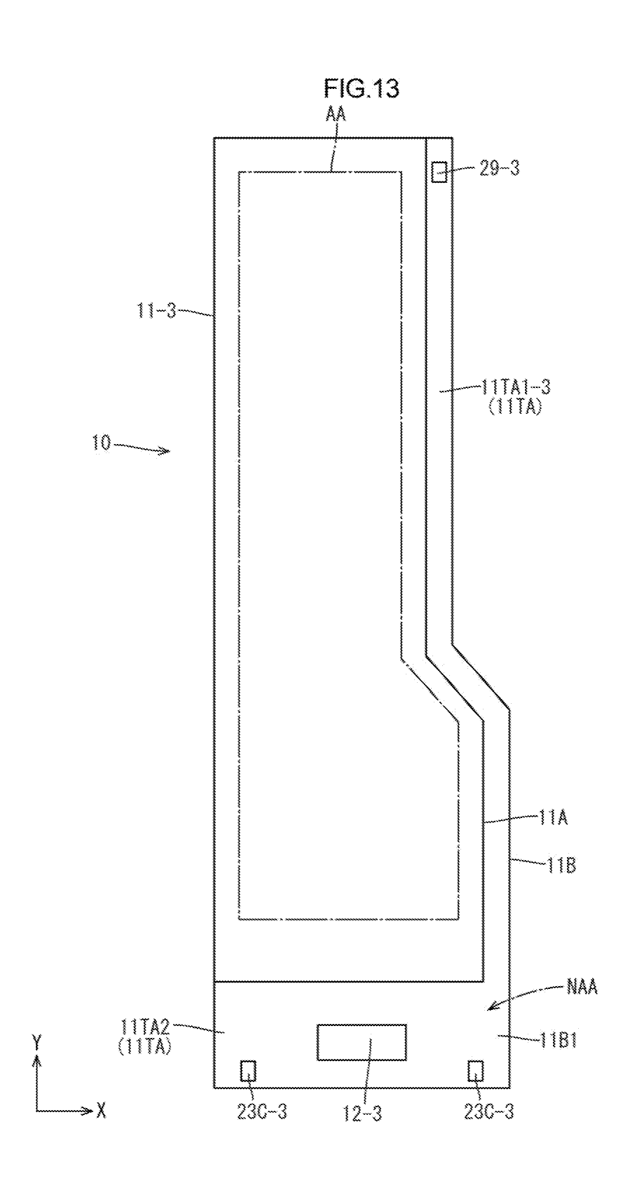

(3) In a modification of the first embodiment, as illustrated in FIG. 13, liquid crystal panel 11-3 has a non-rectangular (odd-shaped) planar shape. In FIG. 13, the central portion of the liquid crystal panel 11-3 in the first direction becomes narrower with increasing distance from the driver 12-3. Correspondingly, a first terminal region 11A1-3 is bent midway in the first direction. In FIG. 13, a capacitive wire sub-terminal portion 29-3 and capacitive wire main terminal portions 23C-3 are illustrated.

(4) The configurations described in (1) to (3) may be applied to the configurations described in the second to the fifth embodiments. It is also possible to apply the configuration described in (5) below to the configurations described in the second to the fifth embodiment.

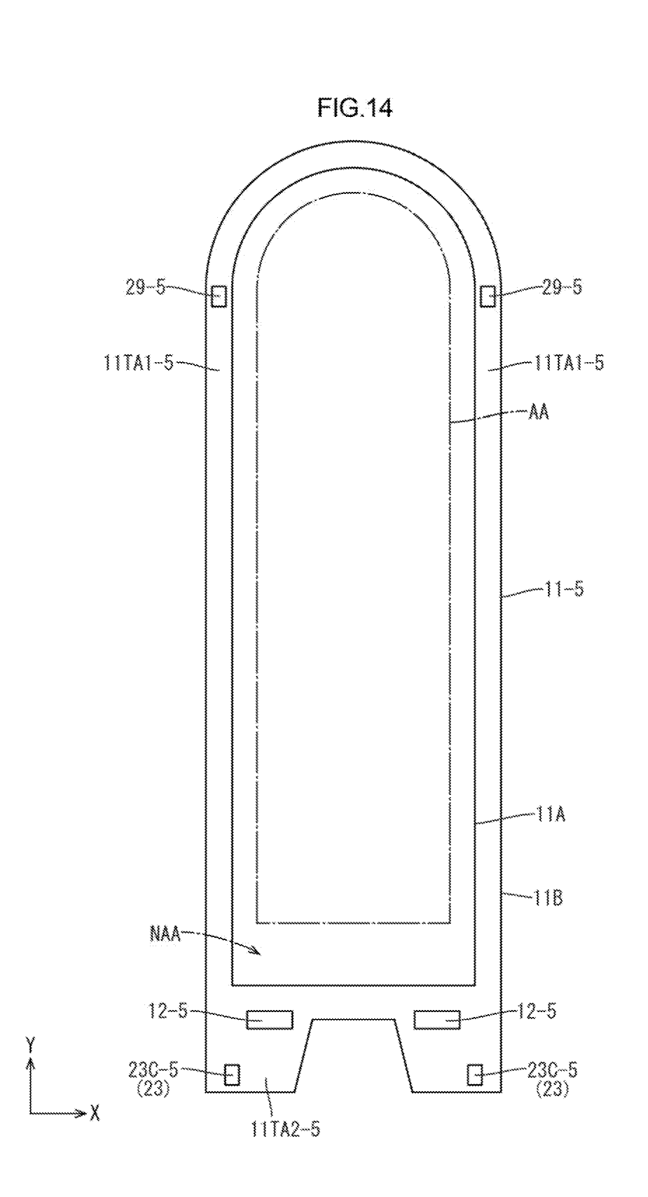

(5) Other than the foregoing embodiments, the specific planar shape of the liquid crystal panel may be modified, as appropriate. Other examples of the planar shape of the liquid crystal panel may include but are not limited to oval, ellipse, triangle, trapezoid, and rhombus. That is, the “long side” described in the embodiments refers to the profile of a relatively long section along the long-axis which is referred to as “longitudinal side substrate end” in the present specification) when the profile of the planar shape of an electronic device having a longitudinal shape is divided into a profile extending generally in the long-axis direction and a profile extending generally in the short-axis direction. The “short side” described in the embodiments refers to the profile of the relatively short section extending in the short-axis direction (referred to as “short-side substrate end” in present specification). Thus, the “longitudinal-side substrate end” does not only refer to a simple linear side, but refers to a concept encompassing a succession or sides and lines other than straight lines, such as deformed lines including a curved line. The “short-side substrate end” may be other than a straight line and may be locally deformed, such as a curved line. Thus, the electronic device having an oblong planar shape may be considered an electronic device having two longitudinal-side substrate ends and two short-side substrate ends. For example, an electronic device having an isosceles triangle planar shape may be considered an electronic device having two longitudinal-side substrate ends and one short-side substrate end. An electronic device having a planar shape including a gentle arc-shaped profile, such as that of the cross section of a cannonball, may be considered an electronic device having two longitudinal-side substrate ends and one short-side substrate end. FIG. 14 illustrates an example of the outer shape of a liquid crystal panel 11-5 (electronic device) having such cannonball-shaped planar shape. In the liquid crystal panel 11-5, the short-side substrate end has a partly recessed planar shape, whereas the end portion on the opposite side has a planar shape that is curved in an arc shape. The liquid crystal panel 11-5 has a pair of first terminal regions 11TA1-5 that is provided with a pair of capacitive wire sub-terminal portions 29-5, and has one second terminal region 11TA2-5 that is provided with a pair of drivers 12-5 and a pair of capacitive wire main terminal portions 23C-5. The one short-side substrate end may be linear.

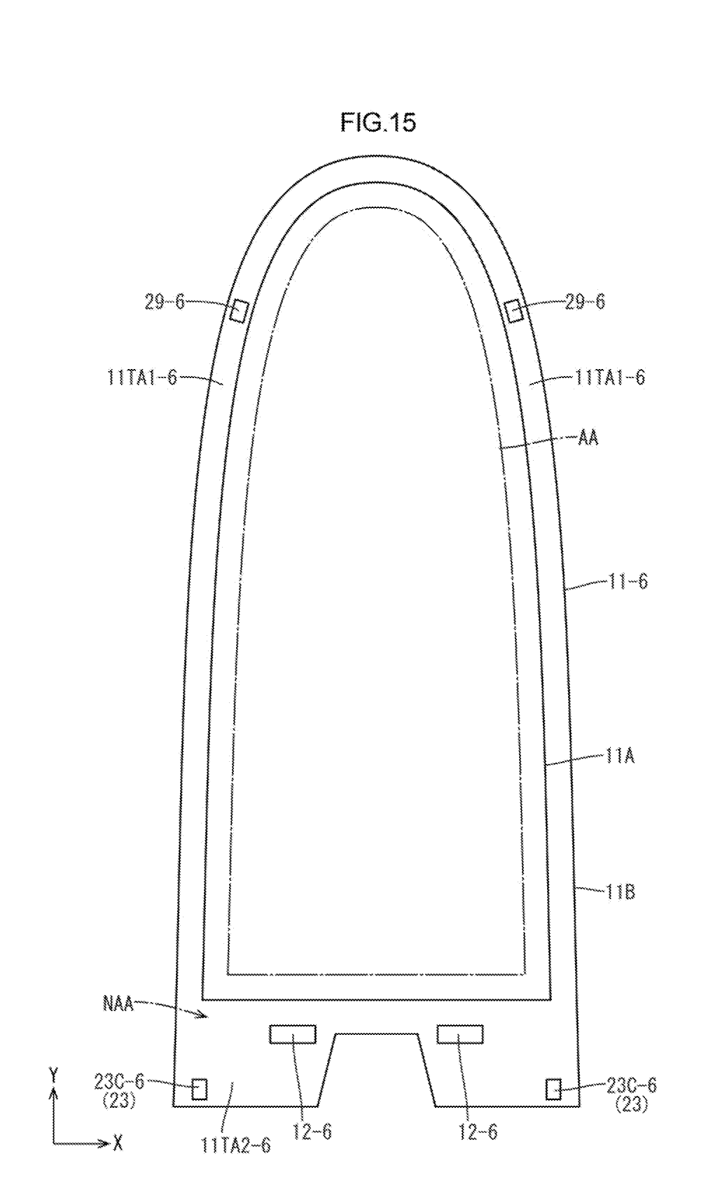

(6) The planar shape of the cannonball-shaped liquid crystal panel may be modified in ways other than the planar shape described in (5) with reference to FIG. 14. For example, as illustrated in FIG. 15, a liquid crystal panel 11-6 has a tapering shape that becomes narrower with increasing distance from the short-side substrate end (second terminal region 11TA2-6) with respect to the longitudinal direction, where a pair of longitudinal-side substrate ends has a non-linear shape. As in (5) described above, a pair of first terminal regions 11TA1-6 is provided with a pair of capacitive wire sub-terminal portions 29-6, and the single second terminal region 11TA2-6 is provided with a pair of drivers 12-6 and a pair of capacitive wire main terminal portions 23C-6.

(7) Other than the first and the second embodiments, the configuration of the capacitive wire may be modified, as appropriate. The second capacitive trunk wire may be omitted. It is also possible to provide only one first capacitive trunk wire.

(8) Other than (7) described above, it is also possible to provide, instead of the capacitive wire, a sol id capacitive electrode similar to the common electrode.

(9) In the foregoing embodiments, the configuration has been described in which both end portions of the gate wires are connected to a pair of monolithic circuit portions. However, a configuration may be adopted in which only one end portion of the gate wires is connected to the monolithic circuit portions. In this case, it is possible, for example, to connect one end portion of odd-numbered gate wires as counted from an end in the first direction to one monolithic circuit portion, and to connect one end portion of even-numbered gate wires to the other monolithic circuit portion.

(10) Other than the foregoing embodiments, it is also possible to install only one monolithic circuit portion.

(11) Other than the foregoing embodiments, it is also possible to make the common electrode provided on the CF substrate an “electrically conductive portion”. The common electrode is connected, via an electrically conductive material (electrically conductive particles) contained in a seal portion, for example, to a common electrode pad portion that is provided on the array substrate side and to which a reference electric potential is applied at all times. Thus, the common electrode is supplied with the reference electric potential. The common electrode pad portion may be arranged each along a long side and a short side, and may be each connected to a first terminal portion provided in the first terminal region and to a second terminal portion provided in the second terminal region.

(12) In the foregoing embodiments, the common electrode is provided on the CF substrate side. Alternatively, the common electrode may be provided on the array substrate side. Such configuration may be preferable for an FFS-mode liquid crystal panel. In a configuration in which the common electrode is provided on the CF substrate side, it is also possible to make the common electrode provided on the CF substrate as described in (11) an “electrically conductive portion”.

(13) In the first embodiment, the single capacitive wire sub-terminal portion is disposed in the vicinity of an end portion in the first direction of the first terminal region. However, the arrangement of the capacitive wire sub-terminal portion in the first direction in the first terminal region may be modified, as appropriate.

(14) In the first and the second embodiments, one capacitive wire main terminal portion is disposed in the vicinity of each of the end portions in the second direction of the second terminal region. However, the arrangement of the capacitive wire main terminal portions in the second direction in the second terminal region may be modified, as appropriate. The number of the capacitive wire main terminal portions that are installed may also be modified, as appropriate.

(15) In the second embodiment, four capacitive wire sub-terminal portions are disposed at regular intervals. However, the specific number of the capacitive wire sub-terminal portions that are installed, and the array interval and the like thereof may be modified, as appropriate. For example, the capacitive wire sub-terminal portions may be arrayed at irregular pitches.

(16) In the third embodiment, two monolithic circuit sub-terminal portions are disposed in the vicinity of an end portion in the first direction of the first terminal region. However, the arrangement and the number of the monolithic circuit sub-terminal portions in the first direction in the first terminal region may be modified, as appropriate.

(17) In the third embodiment, two monolithic circuit main terminal portions are disposed in the vicinity of each of the end portions in the second direction of the second terminal region. However, the arrangement and the number of the monolithic circuit main terminal portions in the second direction in the second terminal region may be modified, as appropriate.

(18) In the fourth embodiment, two each of the first shield pad portions, the first shield terminal portions, and the first shield connection wires are disposed in the vicinity of both end portions in the first direction of the first terminal region. However, the arrangement and the number of the first shield pad portions, the first shield terminal portions, and the first shield connection wires with respect to the first direction in the first terminal region may be modified, as appropriate.

(19) In the fourth embodiment, one second shield pad portion, one second shield terminal portion, and one second shield connection wire are disposed in the vicinity of an end portion in the second direction of the second terminal region. However, the arrangement and the number of the second shield pad portion, the second shield terminal portion, and the second shield connection wire in the second terminal region with respect to the second direction may be modified, as appropriate.

(20) In the fourth embodiment, the shield electrode is directly provided on the plate surface of the CF substrate. Alternatively, the shield electrode may be provided on a polarizing plate affixed to the late surface of the CF substrate, for example.

(21) It is also possible to combine the embodiments. Specifically, two or three from the capacitive wire sub-terminal portion described in the first and the second embodiments, the monolithic circuit sub-terminal portions described in the third embodiment, and the first shield terminal portions described in the fourth embodiment may be provided together in the first terminal region. In this case, the second flexible substrate will be connected with two or three of the capacitive wire sub-terminal portion, the monolithic circuit sub-terminal portions, and the first shield terminal portions.

(22) In the foregoing embodiments, a transmissive liquid crystal display device equipped with a backlight device as an external light source has been described by way of example. However, a reflective liquid crystal display device that makes a display using external may be used. In this case, the backlight device can be omitted. Alternatively, a semi-transmissive liquid crystal display device may be used.

(23) In the foregoing embodiments, TFTs are used as the switching elements of the liquid crystal panel. However, the technology described herein may be applied to a liquid crystal panel in which switching elements other than TFT (such as thin-film diodes (TFD)) are used, or to a liquid crystal panel that makes a black-and-white display, as well as a liquid crystal panel for color display.

(24) In the foregoing embodiments, a liquid crystal panel has been described as an electronic device by way of example. However, other types of display panel (such as a plasma display panel (PDP), an organic EL panel, an electrophoresis display panel (EPD), and a micro electro mechanical systems (MEMS) display panel) may also be used.

1. An electronic device comprising:
a substrate having a longitudinal shape and including a first terminal region disposed in a longitudinal-side substrate end section and a second terminal region disposed in a short-side substrate end section;
an electrically conductive portion extending at least in a first direction along the first terminal region;
a first terminal portion provided in the first terminal region and connected to a part of the electrically conductive portion; and
a second terminal portion provided in the second terminal region and connected to another part of the electrically conductive portion that is spaced apart from the part thereof connected to the first terminal portion with respect to the first direction.

2. The electronic device according to claim 1, wherein
the substrate includes a pair of short-side substrate ends,
the second terminal region is selectively disposed only on one of the short-side substrate ends, and
the first terminal portion is disposed at least in an end portion of the first terminal region on an opposite side from the second terminal region with respect to the first direction.

3. The electronic device according to claim 2, wherein
the electrically conductive portion extends in second direction along the second terminal region, in addition to the first direction;
the longitudinal-side substrate end includes a pair of longitudinal-side substrate ends;
the first terminal region is selectively disposed only on one of the longitudinal-side substrate ends,
the second terminal portion is disposed at least in an end portion of the second terminal region on an opposite side from the first terminal region with respect to the second direction.

4. The electronic device according to claim 3, wherein the second terminal portion is also disposed in an end portion of the second terminal region near the first terminal region the with respect to the second direction.

5. The electronic device according claim 3, wherein the first terminal portion includes first terminal portions that are arranged at intervals respect to the first direction in the first terminal region.

6. The electronic device according to claim 1, wherein the first terminal portion has a dimension with respect to the first direction that is greater than a dimension of the second terminal portion with respect to the second direction along the second terminal region, and the first terminal portion has a dimension with respect to the second direction that is smaller than a dimension of the second terminal portion with respect to the first direction.

7. The electronic device according to claim 6, wherein the first terminal portion has a surface area greater than a surface area of the second terminal portion.

8. The electronic device according to claim 1, wherein the substrate further includes
a display region adjacent to the first terminal region and the second terminal region,
a pixel electrode disposed in the display region,
a signal wire connected to the pixel electrode, and
a driver that is selectively mounted is the second terminal region and supplies the signal wire with a signal.

9. The electronic device according to claim 8, wherein the substrate further includes
a scan wire disposed in the display region,
a switching element disposed in the display region and connected to the scan wire and the signal wire, and
a monolithic circuit portion that is disposed between the display region and the first terminal region, extends in the first direction, is connected to the scan wire, and is configured to drive the switching element.

10. The electronic device according to claim 8, wherein the substrate has a plate surface that is curved about an axis of curvature that is parallel with a second direction along the second terminal region.

11. The electronic device according to claim 10, further comprising a counter substrate disposed so as to oppose the substrate, wherein
the pixel electrode includes pixel electrodes that are arranged in the first direction and the second direction,
the counter substrate includes color filters disposed so as to overlap the pixel electrodes and exhibiting different colors, and
the color filters extend in the first direction and are arranged in the second direction.

12. The electronic device according to claim 1, wherein
the substrate further includes a pixel electrode and a capacitive wire forming a capacitance between the capacitive wire and the pixel electrode, and
the electrically conductive portion is the capacitive wire.

13. The electronic device according to claim 1, further comprising a counter substrate disposed so as to oppose the substrate via a light modulation material, wherein
the substrate further includes a pixel electrode,
the substrate or the counter substrate includes a common electrode opposing the pixel electrode, and
the electrically conductive portion is the common electrode.

14. The electronic device according to claim 1, wherein
the substrate further includes a switching element and a monolithic circuit portion for driving the switching element, and
the electrically conductive portion is the monolithic circuit portion.

15. The electronic device according to claim 1, further comprising a counter substrate disposed so as to oppose the substrate and having a shield electrode provided on a plate surface of the counter substrate on an opposite side from a plate surface opposed to the substrate, wherein
the electrically conductive portion is the shield electrode.

16. The electronic device according to claim 15, further comprising an electrically conductive paste portion extending between the substrate and the counter substrate and connected to the shield electrode, the first terminal portion, and the second terminal portion, wherein
the counter substrate is disposed so as to not overlap the first terminal portion and the second terminal portion.
